(19) United States
(12) Patent Application Publication
(10) Pub. No.: US 2016/0260174 A1
(43) Pub. Date: Sep. 8, 2016

(54) SYSTEMS AND METHODS FOR PROVIDING MANAGEMENT OF STRUCTURED SETTLEMENTS

(71) Applicant: Chronovo, Inc., Burlington, MA (US)

(72) Inventors: Gurdip Singh, Burlington, MA (US); Jack Plunkett, Greenville, ME (US); Kenneth John Paradis, Concord, MA (US); William David Wakelee, Downingtown, PA (US)

(21) Appl. No.: 14/796,446

(22) Filed: Jul. 10, 2015

Related U.S. Application Data
(60) Provisional application No. 62/127,713, filed on Mar. 3, 2015.
(60) Provisional application No. 62/127,710, filed on Mar. 3, 2015.

(51) Int. Cl. G06Q 40/06; G06Q 50/18

(52) U.S. Cl. CPC G06Q 40/06; G06Q 50/18

(57) ABSTRACT

Systems and methods are presented for managing structured settlements associated with cases. A first input is received at a structured settlement system from a first user. The first input comprises instructions to access a graphical user interface comprising at least one of: a diary interface; a settlement dashboard interface; a quoting interface a quote modification interface comprising prompts for receiving quote data, wherein one of the quotes is calculated based at least in part on the received quote data; and a chronograph interface. One or more interface inputs are received from the first user via the graphical user interface. The one or more interface inputs are processed in real-time.

### CROSS-REFERENCE TO RELATED APPLICATION

The present application claims priority to and the benefit of U.S. Patent Application No. 62/127,710 and 62/127,713, titled “Systems and Methods for Providing Management of Structured Settlements,” and filed on Mar. 3, 2015, the entire contents of which are hereby incorporated by reference herein.

### FIELD OF THE INVENTION

The present invention generally relates to structured settlements, and more particularly to systems and methods for providing management of structured settlements.

### BACKGROUND

Structured settlements are financial and/or insurance arrangements in which claimants in an action (e.g., legal action) receive payments in exchange for or as a result of the resolution of the action. Typically, the payments received by claimants are periodic payments crated through the purchase of financial instruments guaranteeing future payments, such as annuities Annuities of the same value may be purchased from a multitude of insurance providers (e.g., life insurance providers, structured settlement underwriters) at varying costs (e.g., premiums). Depending on the quality of the annuity, long term income and benefits may be gained by the claimants, beneficiaries, and/or defendants.

In this regard, structured settlements often involve a number of participants, including claimants (e.g., injured parties), defendants (e.g., insurance carriers), beneficiaries (e.g., parties to receive benefits of claim), claims professionals (e.g., claim negotiators and/or adjusters), life companies (e.g., insurance providers, annuities underwriters), and the like. Defendants owing payments (e.g., judgments) to claimants and/or beneficiaries, to be paid over a long term (e.g., structured settlement), typically purchase annuities from insurance providers to satisfy the payment obligation. In turn, the insurance providers pay the periodic payments under the annuity to the claimants and/or beneficiaries.

There is a need, therefore, for systems and methods for linking life companies, companies, participants, adjusters, and the like, and for allowing customers (e.g., participants, claims professionals, case advocates) to manage structured settlements, for example, by requesting quotes, viewing quotes, selecting quotes, tracking quotes, comparing quotes, communicating with insurance providers, obtaining long range financial benefits, and the like. There is also a need for providing said functionality in single interfaces provided directly to customers. There is also a need for providing real-time quotes to customers to provide them with a most beneficial quote-shopping experience.

### SUMMARY

The example embodiments presented herein are directed to systems and methods for providing management of structured settlements.

In some example embodiments, a method is provided for managing structured settlements associated with cases, the method comprising: receiving, by a processor of a structured settlement system, a first input from a first user, the first input comprising instructions to access a graphical user interface provided by a structured settlement system; causing to display, by the processor of the structured settlement system, the graphical user interface in response to the instructions in the first input, the graphical user interface comprising at least one of: (i) a diary interface comprising case data corresponding to one or more of the cases associated with the first user; (ii) a settlement dashboard interface comprising settlement metrics associated with one or more of the cases associated with the first user; (iii) a quoting interface comprising prompts for receiving quote data for a new case, wherein one or more quotes are calculated based at least in part on the received quote data; (iv) a quote modification interface comprising prompts for receiving quote data, wherein one of the quotes is calculated based at least in part on the received quote data; and (v) a chronograph interface comprising quote data of a quote associated with one of the cases; receiving, by the processor of the structured settlement system, one or more interface inputs from the first user, the one or more interface inputs being received via the graphical user interface; and processing, by the processor of the structured settlement system, the one or more interface inputs in real-time.

In some example embodiments, the graphical user interface is caused to be displayed, by the processor of the structured settlement system, at a display of a computing device associated with the first user.

In some example embodiments, the quote data received by the processor of the structured settlement system via the quoting interface is selected from the group comprising a quote type, claim number, purchase date, adjuster, structure amount, upfront cash, attorney fees, lien amount, annuitant name, annuitant birth date, annuitant age, and annuitant gender. The quote data is received from one or more of a memory communicatively coupled to the structured settlement system or over a network from a computing device associated with the first user. The method further comprises obtaining in real time, by the processor, one or more quotes associated with life companies, the one or more quotes being obtained based in part on the quote data, one or more rules and one or more rates associated with the life companies.

In some example embodiments, the structured settlement system is integrated with rate generation software associated with the life companies, the rate generation software comprising rating algorithms used to calculate the one or more rates used to obtain the one or more quotes.

In some example embodiments, the method comprises identifying, by the processor, a best fit quote from among the one or more quotes, the best fit quote representing the quote with the best financial advantage to the annuitant based in part on configuration tables including predetermined based configurations.

In some example embodiments, the first user is an adjuster associated with an adjuster computing device.

In some example embodiments, the method comprises: receiving, by the processor, via the chronograph interface, quote inputs; calculating, by the processor, updated quote data based on the received quote inputs; and displaying in real time, by the processor, at least a portion of the updated quote data and graphical representations of the at least a portion of the updated quote data.

In some example embodiments, the chronograph interface includes one or more slider widgets, and wherein the quote inputs are received via the slider widgets.

In some example embodiments, the graphical representations include charts illustrating the financial impact of a quote associated with the updated quote data relative to traditional investments.

In some example embodiments, the settlement metrics are selected from a group comprising quoted cases, pending cases, locked in cases, awaiting cases, settled cases, expected settlements, completed settlements, percent achieved, and current savings per claim.

In some example embodiments, the settlement metrics correspond to cases associated with the first user based on the role of the first user stored a memory communicatively coupled to the structured settlement system.

In some example embodiments, the settlement metrics are calculated on a month-to-date, quarter-to-date, or year-to-date basis.

In some example embodiments, the settlement dashboard is used to manage the performance of the first user based in part on the settlement metrics.

In some example embodiments, the one or more quotes are caused to be displayed in a quote comparison interface.

In some example embodiments, the method comprises: receiving, by the processor, via the quoting interface, quote data; obtaining, by the processor, one or more quotes associated with life companies, based in part on the quote data received via the quoting interface; identifying, by the processor, a best fit quote from among the one or more quotes; outputting, by the processor, the one or more quotes, wherein the best fit quote is highlighted in contrast to others of the one or more quotes, wherein the outputting is performed in real time relative to the receiving of the quote data via the quoting interface; causing to display, by the processor, via the chronograph interface, the quote data of one of the one or more quotes; receiving, by the processor, via the chronograph interface, quote inputs; and causing to display, by the processor, via the chronograph interface, updated quote data based in part on the quote inputs.

In some example embodiments, a system is provided for managing structured settlements associated with cases, the system comprising: at least one memory, and a processor communicatively coupled to the at least one memory. The processor is operable to: receive, by the processor, a first input from a first user, the first input comprising instructions to access a graphical user interface provided by a structured settlement system; cause to display, by the processor, the graphical user interface in response to the instructions in the first input, the graphical user interface comprising at least one of: (i) a diary interface comprising case data corresponding to one or more of the cases associated with the first user; (ii) a settlement dashboard interface comprising settlement metrics associated with one or more of the cases associated with the first user; (iii) a quoting interface comprising prompts for receiving quote data for a new case, wherein one or more quotes are calculated based at least in part on the received quote data; (iv) a quote modification interface comprising prompts for receiving quote data, wherein one of the quotes is calculated based at least in part on the received quote data; and (v) a chronograph interface comprising quote data of a quote associated with one of the cases; receive, by the processor, one or more interface inputs from the first user, the one or more interface inputs being received via the graphical user interface; and process, by the processor, the one or more interface inputs in real-time.

In some example embodiments, the processor is further operable to: receive, by the processor, via the quoting interface, quote data; obtain, by the processor, one or more quotes associated with life companies, based in part on the quote data received via the quoting interface; identify, by the processor, a best fit quote from among the one or more quotes; output, by the processor, the one or more quotes, wherein the best fit quote is highlighted in contrast to others of the one or more quotes, wherein the outputting is performed in real time relative to the receiving of the quote data via the quoting interface; cause to display, by the processor, via the chronograph interface, the quote data of one of the one or more quotes; receive, by the processor, via the chronograph interface, quote inputs; and cause to display, by the processor, via the chronograph interface, updated quote data based in part on the quote inputs.

In some example embodiments, Systems and methods are provided for managing structured settlements. A plurality of claims is stored. First instructions to adjust one or more parameters associated with one of the plurality of claims are received from a first claim management system. The first instructions include first updated parameter values. A first quote request including at least a portion of the one of the plurality of claims is transmitted to one or more life company systems. A first quote is received from each of the one or more life company systems. Each of the first quotes is based on the one or more parameters adjusted using the first updated parameter values. The first quotes received from each of the one or more life company systems are transmitted to the first claim management system.

In some example embodiments, a customer-facing interface enables claims professionals to self-service, create quote estimates, manipulate estimates in real-time while negotiating settlements, track their cases, and compare quotes, features, and ratings from the life companies who underwrite the annuities.

In some example embodiments, a chronograph interface is a single interface that enables the claims professional to, among other things: adjust quote parameters and allocations between types of benefits and determine what impacts to long-term income and benefits; leverage proprietary formulae or algorithm to calculate the impact of annuities and allocations on long-term income (e.g., long term financial forecast or structure settlement); secure instantaneous ranges of quotes from different life insurance companies that underwrite structured settlements (e.g., instant price comparison); capture each iteration of quotes enabling claims professionals to track the progress of negotiations (e.g., chronograph tracker); publish, display and/or transmit quotes (e.g., working quotes) to parties to an action and/or litigation via a one to two page quote including finalized (e.g., locked in) graphs; and configure suggested quotes based on specifics of claimants' profiles and parameters created by a structured settlement management system (e.g., annuity wizard).

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a diagram of a system for providing management of structure settlements according to an exemplary embodiment.

FIG. 2. is a flow diagram illustrating a process for managing structured settlements according to an exemplary embodiment.

FIG. 3 illustrates a log in interface for accessing structured settlement services and/or functionality according to an exemplary embodiment.

FIG. 4A illustrates an interface for resetting a password according to an exemplary embodiment.

FIG. 4B illustrates an interface for managing an account according to an exemplary embodiment.

FIG. 5A illustrates an interface for managing users' information according to an exemplary embodiment.

FIG. 5B illustrates an interface for managing user information according to an exemplary embodiment.

FIG. 5C illustrates an interface for managing users' information according to an exemplary embodiment.

FIG. 5D illustrates an interface for managing users' information according to an exemplary embodiment.

FIG. 6A illustrates an interface for managing life company information according to an exemplary embodiment.

FIG. 6B illustrates an interface for managing life company information according to an exemplary embodiment.

FIG. 6C illustrates an interface for managing company information according to an exemplary embodiment.

FIG. 6D illustrates an interface for managing company information according to an exemplary embodiment.

FIG. 6E illustrates an interface for managing company information according to an exemplary embodiment.

FIG. 7A illustrates interfaces for managing contact information associated with a structured settlement provider.

FIG. 7B illustrates interfaces for managing contact information associated with a structured settlement provider.

FIG. 8A illustrates interfaces for managing multi-tenanted information associated with a structured settlement provider.

FIG. 8B illustrates interfaces for managing multi-tenanted information associated with a structured settlement provider.

FIG. 9A illustrates a diary interface for managing cases according to an exemplary embodiment.

FIG. 9B illustrates a settlement dashboard for managing structured settlements according to an exemplary embodiment.

FIG. 9C illustrates a case search interface according to an exemplary embodiment.

FIG. 9D illustrates an diary entry interface for adding diary entries according to an exemplary embodiment.

FIG. 9E illustrates a case data interface for viewing and/or modifying case data associated with a diary entry.

FIG. 10A illustrates an interface for generating a quote (e.g., SmartQuote) according to an exemplary embodiment.

FIG. 10B illustrates an interface to modify life company selections in a quoting process according to an exemplary embodiment.

FIG. 10C illustrates an interface for setting and/or configuring base quotes according to an exemplary embodiment.

FIG. 11A illustrates an interface for modifying annuitant information according to an exemplary embodiment.

FIG. 11B illustrates an interface for modifying benefits information associated with a quote, according to an exemplary embodiment.

FIG. 11C illustrates an interface for finalizing quote modifications accordion to an exemplary embodiment.

FIG. 12A illustrates a chronograph interface for managing quotes according to an exemplary embodiment.

FIG. 12B illustrates a chronograph settlement proposal according to an exemplary embodiment.

FIG. 12C illustrates a chronograph settlement proposal according to an exemplary embodiment.

FIG. 13 illustrates an interface for quote shopping according to an exemplary embodiment.

FIG. 14 illustrates a quote comparison interface according to an exemplary embodiment.

FIG. 15A illustrates a medical savings account (MSA) checklist interface according to an exemplary embodiment.

FIG. 15B illustrates a workers compensation (WC) checklist interface according to an exemplary embodiment.

FIG. 15C illustrates a liability checklist interface according to an exemplary embodiment.

FIG. 16A illustrates an interface for managing documents associated with a settlement according to an exemplary embodiment.

FIG. 16B illustrates an interface for adding documents to a case according to an exemplary embodiment.

FIG. 16C illustrates a diary interface for managing diary entries according to an exemplary embodiment.

FIG. 17 shows an illustrative network environment for use in the methods and systems for managing structured settlements, as described herein.

FIG. 18 shows an example of a computing device and a mobile computing device that can be used in the methods and systems described in this disclosure.

### DETAILED DESCRIPTION

The example embodiments described herein are directed to systems and methods for providing management of structure settlements.

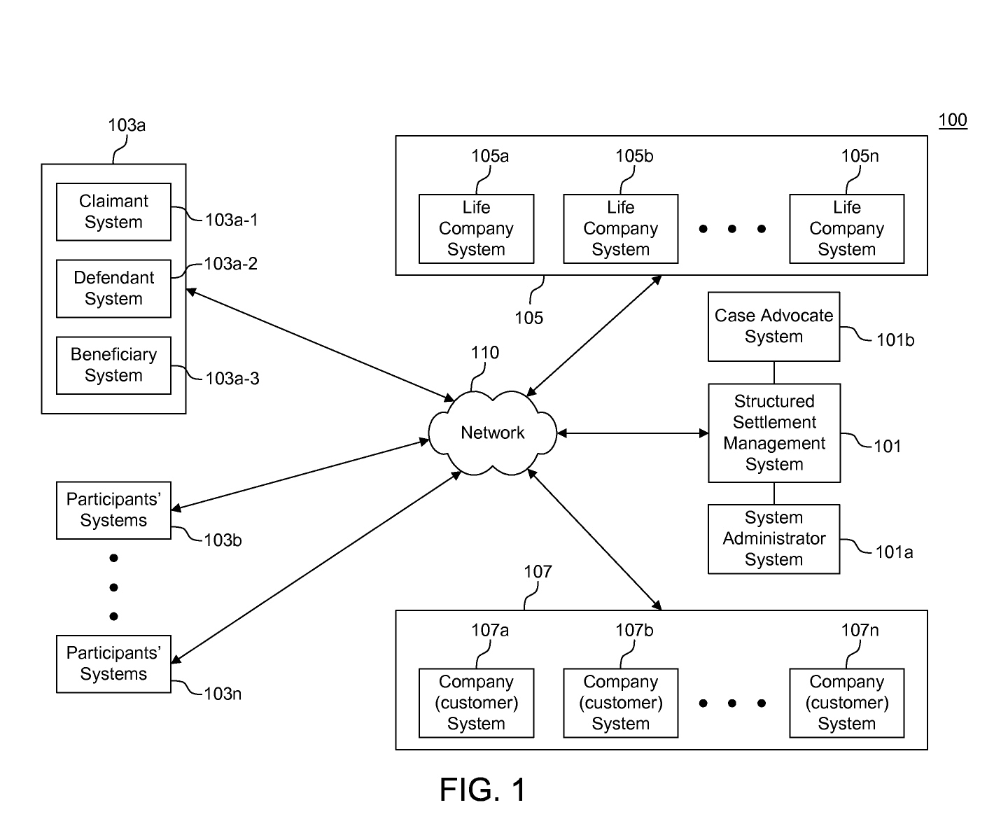

FIG. 1 is a diagram of a system 100 for providing management of structure settlements according to an exemplary embodiment. In certain embodiments, the system 100 is an architecture, ecosystem, or the like that comprises numerous systems or subsystems (e.g., devices, servers, networks, and the like). As shown in FIG. 1, the system 100 includes a structured settlement provider system 101; participants' systems 103a, 103b, . . . , 103n (collectively “103” or “participants' systems 103”); life companies' systems 105 (e.g., life insurance company); and company (e.g., customer) companies' systems 107. The participants' systems 103 may include one or more of a claimant system, defendant system, and/or beneficiary system. For example, the participants' systems 103a include a claimant system 103a-1, a defendant system 103a-2, and a beneficiary system 103a-3, for instance, associated with a single case. It should be understood that, In certain embodiments, a claimant system and a beneficiary system may be managed by the same user and/or may be the same system. That is, In certain embodiments, the claimant and beneficiary (e.g., annuitant) may be the same person. The life companies' systems 105 include life company systems 105a, 105b, . . . , and 105n. The claims professionals systems' 107 include company systems 107a, 107b, . . . , and 107n.

Each of the systems 101, 103, 105, and 107 may include one or more computing and or electronic devices equipped with hardware (e.g., processor, storage means) and/or software. For example, the systems 101, 103, 105, and 107 may include one or more servers such as database servers, file servers, mail servers, print servers, web servers, gaming servers, application servers, and the like. The systems 101, 103, 105, and 107 may also and/or alternatively include laptops, desktops, mobile devices, tablets, wearable devices, workstations, personal digital assistants, servers, blade servers, mainframes, and the like.

The structured settlement provider system 101, participants' systems 103, life companies' systems 105, and companies' systems 107 may be connected through a network 110. The network 110 may be a virtual private network (VPN), local area network (LAN), personal area network (PAN), wide area network (WAN), the Internet, and the like. It should be understood that although the network 110 is illustrated as a single element in FIG. 1, the network 110 may include any number and combination of networks.

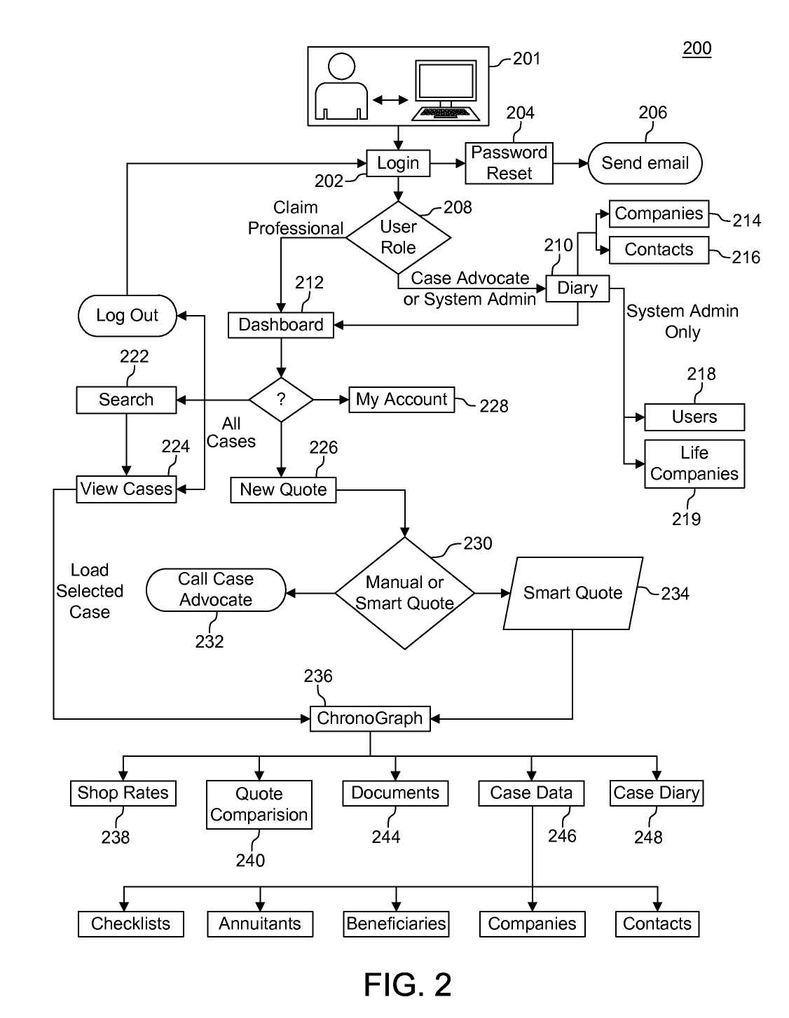

The structured settlement provider system 101 may include hardware and/or software managed, operated, and/or owned by a structured settlement provider company, organization, institution, individual, or the like. The structured settlement provider system 101 enables structured settlement providers to manage (e.g., buy, sell) structure settlements among life insurance companies or providers (e.g., life companies' systems 105), participants (e.g., participants' systems 103), and claims professionals (e.g., companies' systems). More specifically, the structured settlement provider system 101 may include and/or provide customer-facing interfaces and/or services for, among other things, accessing self-service resources; creating quote estimates; manipulating quote estimates (e.g., in real time); negotiating settlements; tracking cases; and comparing quotes, features and ratings of life companies. It should be understood that “customer-facing” (e.g., customer-facing interfaces) refers to the concept of providing functionality to customers (e.g., companies (e.g., companies' systems 107), users, insurance providers, participants (e.g., participants' systems 103), claims professionals, adjusters) via their respective systems and or computing devices. In certain embodiments, “customer-facing” refers to the ability of customers to have access (e.g., direct access) to an interface (e.g., graphical user interface) provided, generated, rendered and/or facilitated by the structured settlement provider system 101. The customer-facing interfaces and/or services provided by the structured settlement provider system 101 are described in further detail below with reference to FIGS. 2 to 16.

Moreover, the structured settlement provider system 101 includes and/or is associated with a system administrator system 101a. The system administrator system 101a may include hardware and/or software managed, operated, and/or owned by a system administrator of the structured settlement provider corresponding to the structured settlement provider system 101. In certain embodiments, the system administrator system 101a has unique rights to access and/or modify the structured settlement provider system 101, including data stored and/or associated with the structured settlement provider system 101. Although only a single system administrator system 101a is illustrated in FIG. 1, it should be understood that any number of system administrator systems may be associated with and/or included in the structured settlement provider system 101.

The structured settlement provider system 101 includes and/or is associated with case advocate systems (e.g., case advocate system 101b). In certain embodiments, case advocates systems are managed by case advocates, which may be referred to as brokers. In some example embodiments, the structured settlement system 101 is referred to as a broker (or broker system) made up of any number of case advocates (or case advocate systems). The case advocate system 101b may include hardware and/or software managed, operated, and/or owned by a case advocate of the structured settlement provider corresponding to the structured settlement provider system 101 or by the structured settlement provider system 101 itself. In certain embodiments, the case advocate system 101b may be used to buy, sell, solicit and/or negotiate annuities and/or other financial instruments, for example, from life company systems 105. Although only a single case advocate system 101b is illustrated in FIG. 1, it should be understood that any number of case advocate systems may be associated with and/or included in the structured settlement provider system 101.

In certain embodiments, the structured settlement provider system 101 is connected to (e.g., via a network) and/or associated with one or more adjuster systems (not illustrated in FIG. 1). Adjuster systems may be computing devices or the like that are accessed, controlled, and/or managed by insurance claims adjusters who investigate claims to determine an life company's liability. In certain embodiments, the claims adjusters and/or the adjusters' systems are controlled and/or operated by one or more of the life company systems 105 or the company systems 107. In certain embodiments, the claims adjusters and/or the adjusters' systems are independent and not associated with any system in the system 100.

The participants' systems 103 may include hardware and/or software managed, operated, and/or owned by respective participants (e.g., claimants, defendants, beneficiaries) to or of a case. In certain embodiments, a case refers to a legal action, investigation, suit, and/or the like between a claimant and a defendant, including product liability and injury cases. In certain embodiments, a claimant in a case refers to an injured party or the like seeking damages (e.g. funds, payments). In certain embodiments, the damages may be sought from a defendant, which may be an insurance provider (e.g., property or casualty insurance company) or the like. In certain embodiments, a beneficiary refers to an individual, company, organization or the like that receives and/or is expected to receive benefits resulting from a case (e.g., funds, payments). It should be understood that, in certain embodiments, a beneficiary and a claimant may refer to the same party.

The company systems 107 may include hardware and/or software managed, operated and/or owned by respective claims professionals, such as claims professional companies, organizations, institutions, individuals, or the like. The companies (e.g., corresponding to the company systems 107) and/or their corresponding claims professionals may be referred to as customers. That is, in some embodiments, the company systems 107 act as customers of the structured settlement management system 101 by purchasing or transacting policies via the structured settlement management system 101 (e.g., from the life companies 105). In certain embodiments, claims professionals may be claims adjusters or any individual or entity that assists in the investigation, negotiation, and other matters related to claims arising out of and/or associated with cases. Claims may be insurance claims or the like, in which claimants seek payment, funds, and the like from insurance companies. In certain embodiments, claims professionals create quote estimates, manipulate quote estimates, and compare quote estimates during settlements (e.g., structured settlements, structured claim settlements) between claimants and defendants. To that end, claim professionals, using corresponding systems (e.g., companies' systems 107), utilize (e.g., access) services and/or interfaces provided by the structured settlement provider system 101, in order to reach a settlement (e.g., structured settlement).

The life companies' systems 105 may include hardware and/or software managed, operated and/or owned by respective life companies, life insurance providers, or the like. Life companies may be life insurance companies, assignment companies, annuity selling companies, financial services companies, and the like. In certain embodiments, the life companies sell and/or provide annuities and/or payments to claimants, for example, via life companies' systems 105. For example, in a legal case resulting in a structured settlement that provides the claimant with benefits (e.g., funds, payments), the defendant in the case may purchase an annuity from a life company (e.g., life company system 105a), via the structured settlement manage company (or system), in order to have the benefits paid to the claimant and/or beneficiary in accordance with the structured settlement's specifications (e.g., amount, timing, etc.). In other example embodiments, an annuity may be purchased by a company (e.g., company 107a) on behalf of a participant, via the structure settlement management company, from a life company.

FIG. 2. is a flow diagram 200 (e.g., interface flow diagram) illustrating a process for managing structured settlements according to an exemplary embodiment. In certain embodiments, the flow diagram 200 illustrates a process for managing and/or accessing the services and/or interfaces provided by the structured settlement provider system 101. It should be understood that “interface” (e.g., interface flow diagram) refers to a graphical rendering, representation, and/or a graphical user interface generated, presented, and/or caused to be displayed by the structured settlement provider system 101, for example, via a web browser, software application or the like. It should be understood that the interfaces and/or widgets described herein are merely exemplary, and can be rearranged, modified, resized, and the like, so long as their purpose and/or desired outcome is still achievable.

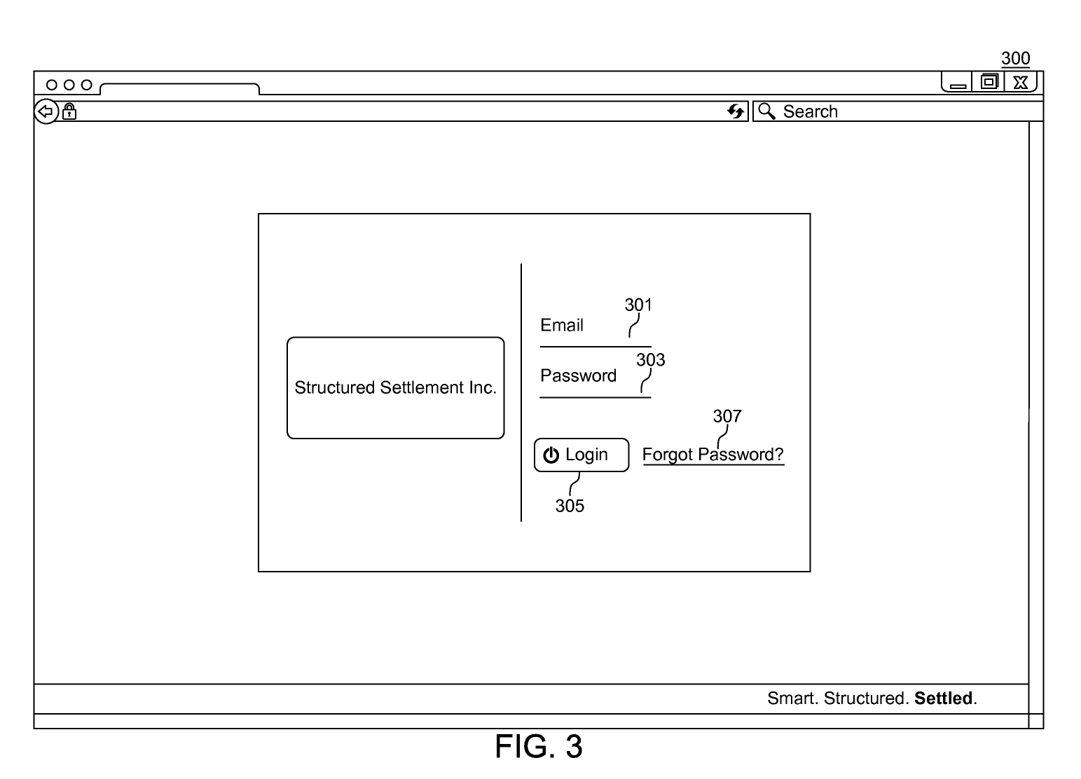

At step 202, a login interface is presented to a customer and/or user via their corresponding computing device (collectively “customer 201,” “user 201,” or “201”). A customer and/or user may be a participant associated with a participant system (e.g., claimant system 103a-1, defendant system 103a-2, beneficiary system 103a-3); a claims professional associated with a company system (e.g., company system 107a); an life insurance provider associated with a life company system (e.g., life company system 105a); a claim adjuster associated with an adjuster system; or a structured settlement provider associated with a structured settlement provider system (e.g., structured settlement provider system 101, system administrator system 101a, case advocate system 101b). The login interface is used to access services and/or interfaces provided by the structured settlement provider system 101. The login interface presented at step 202 is described in further detail below with reference to FIG. 3.

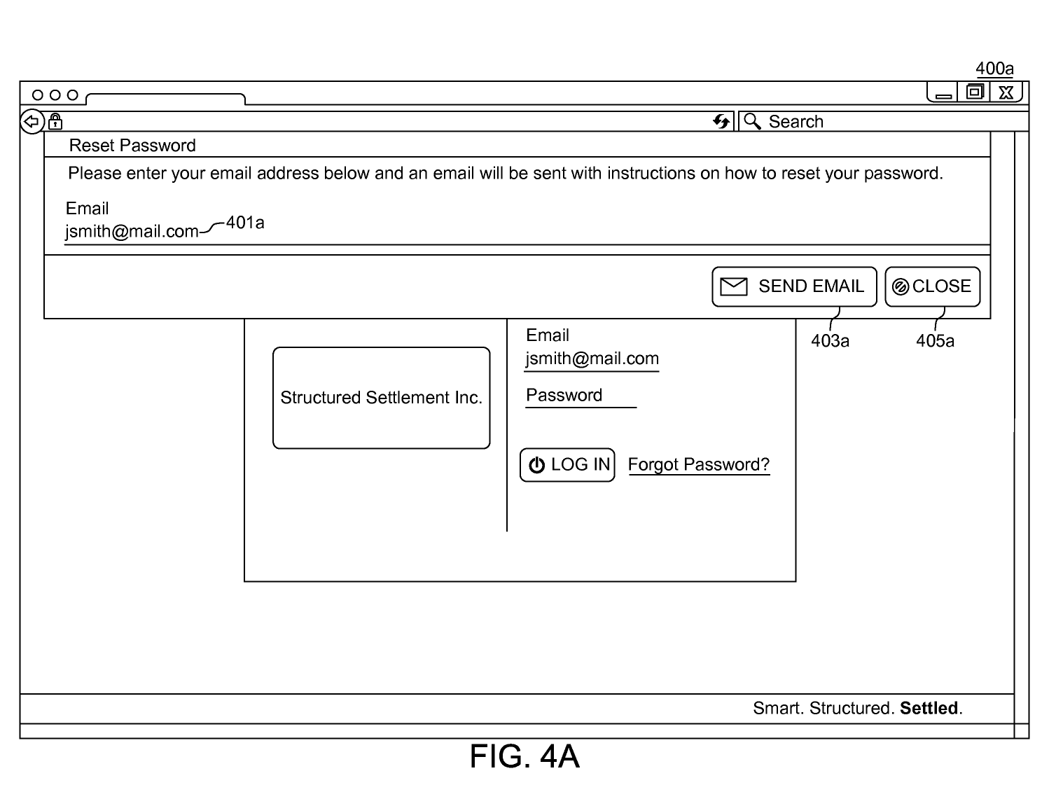

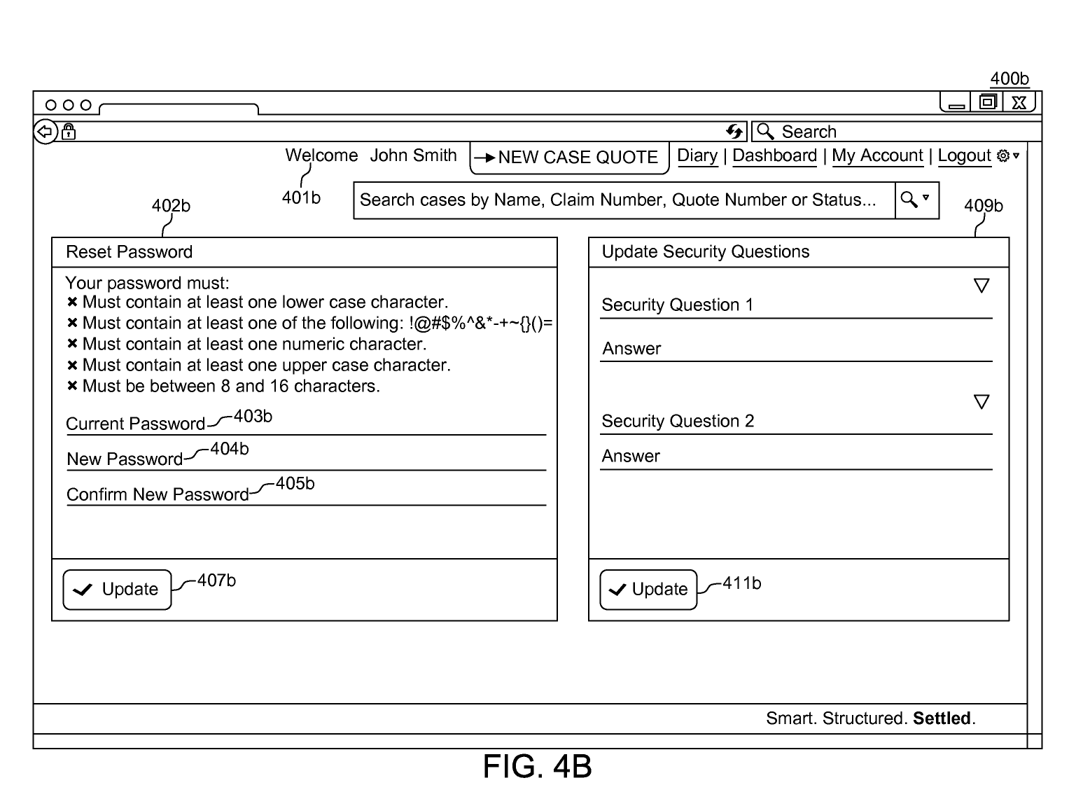

In turn, if access at step 202 fails, or if the user 201 elects to reset a password (e.g., account password), a password reset interface to reset a password is presented to user 201 at step 204. In certain embodiments, resetting a password includes transmitting an e-mail to the user 201 (step 206). The password reset confirmation interface and reset password interface presented at steps 204 and 206 are described in more detail below with reference to FIGS. 4A and 4B, respectively.

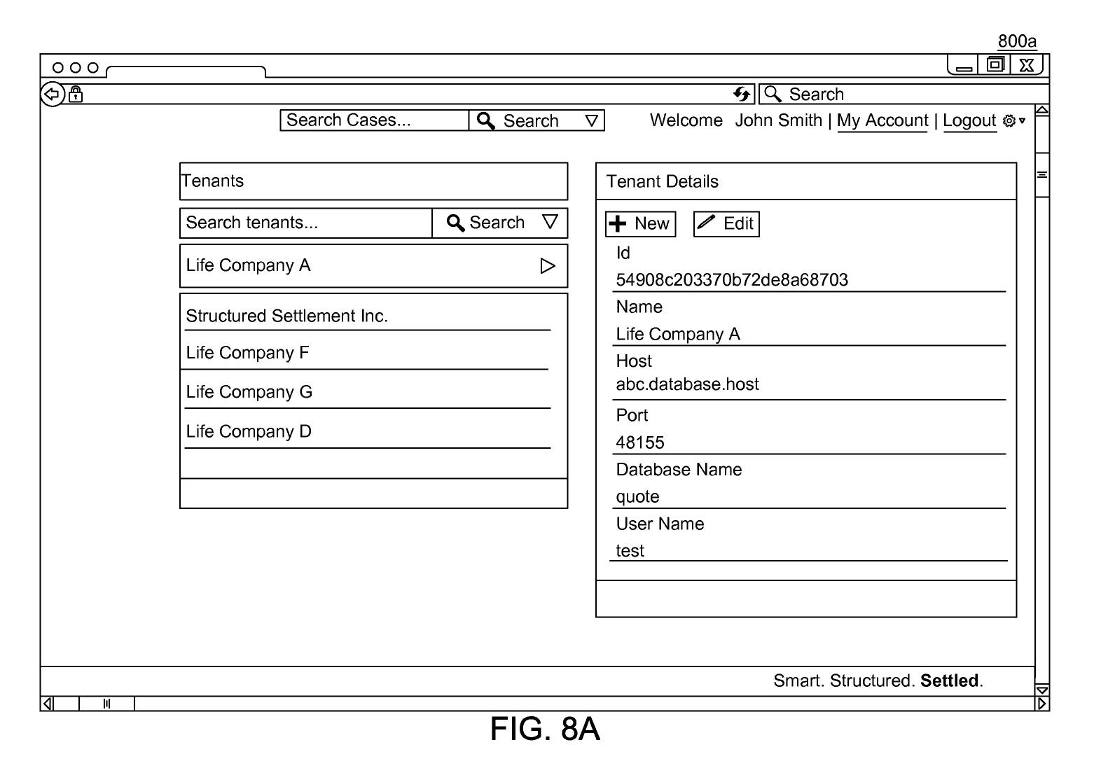

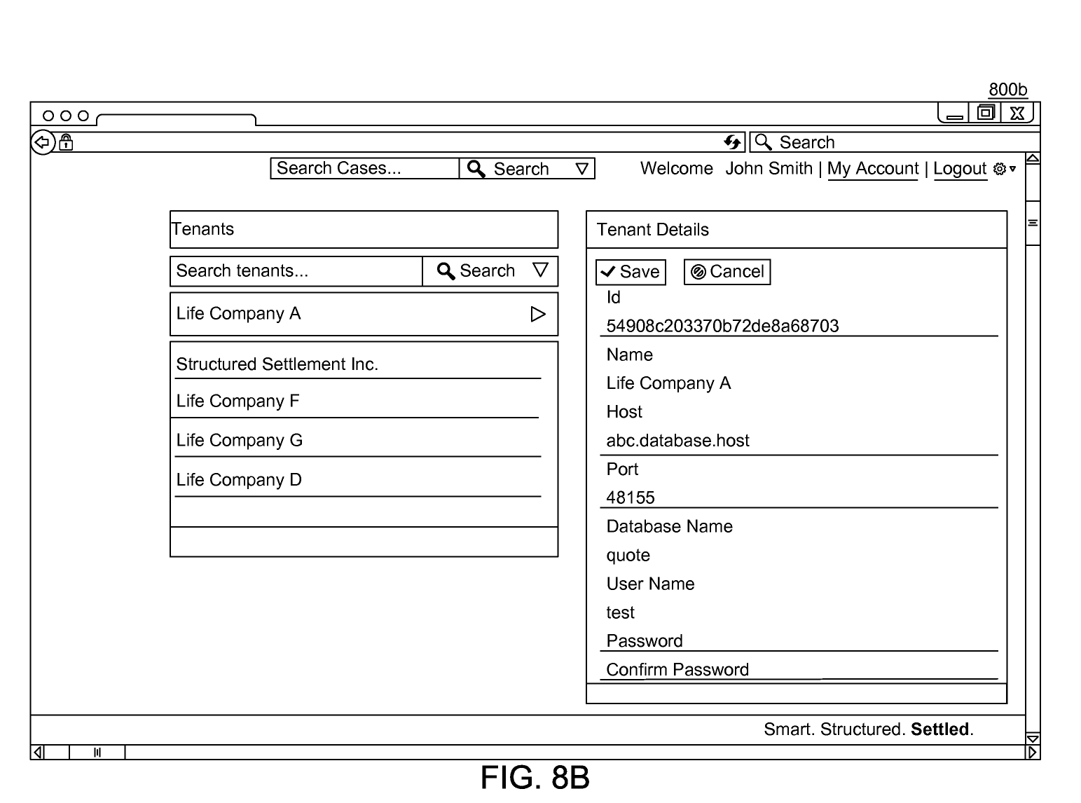

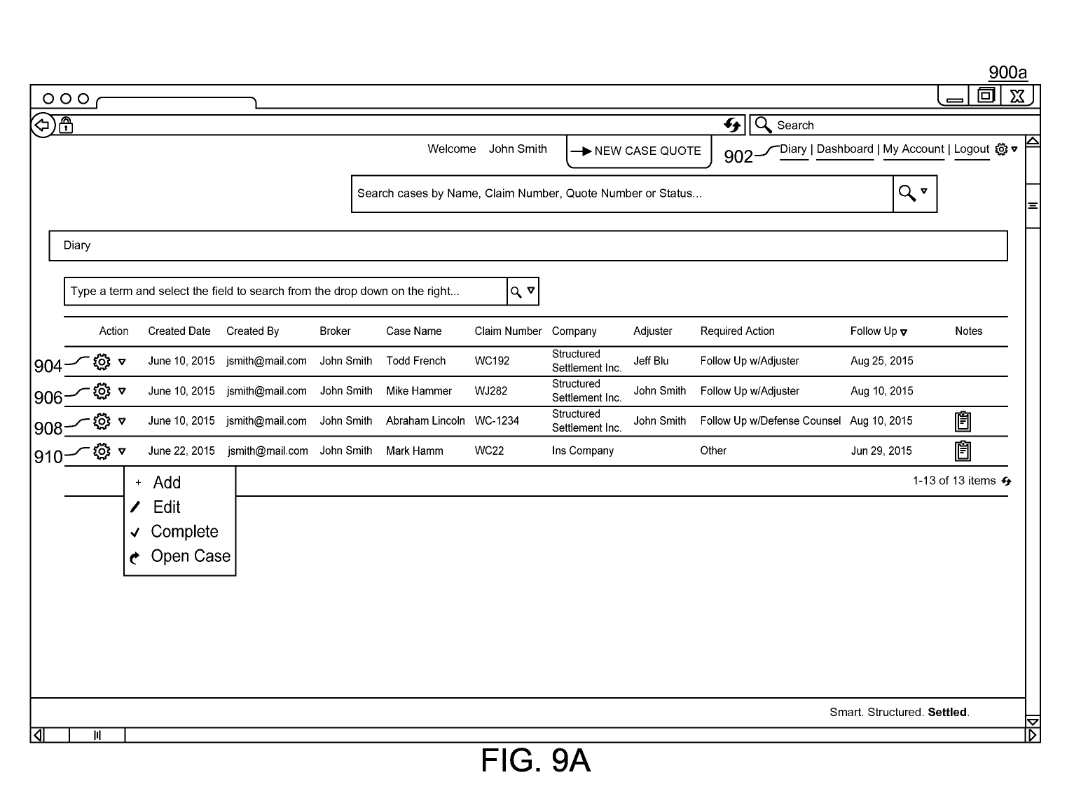

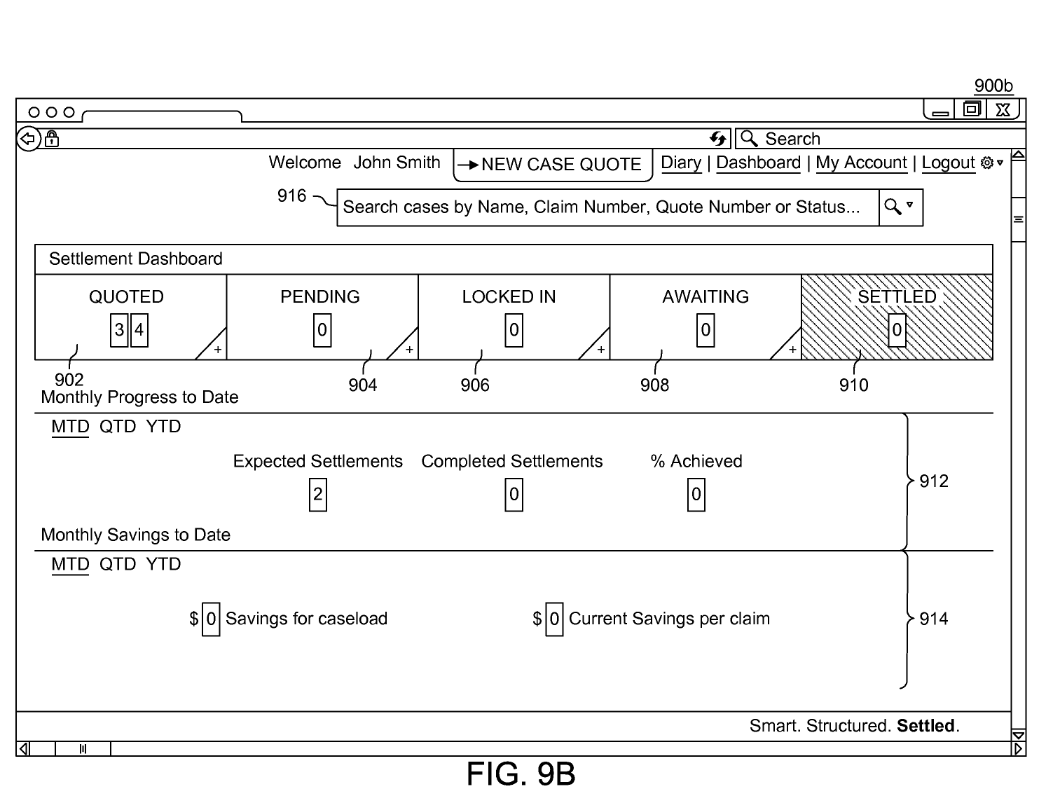

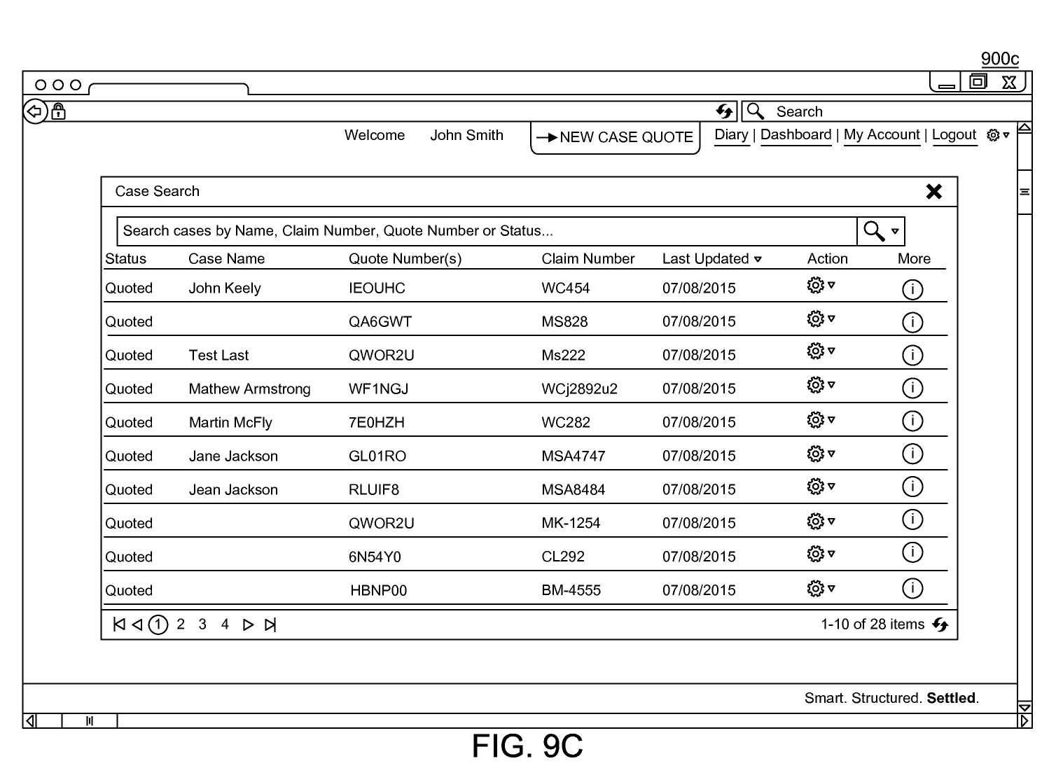

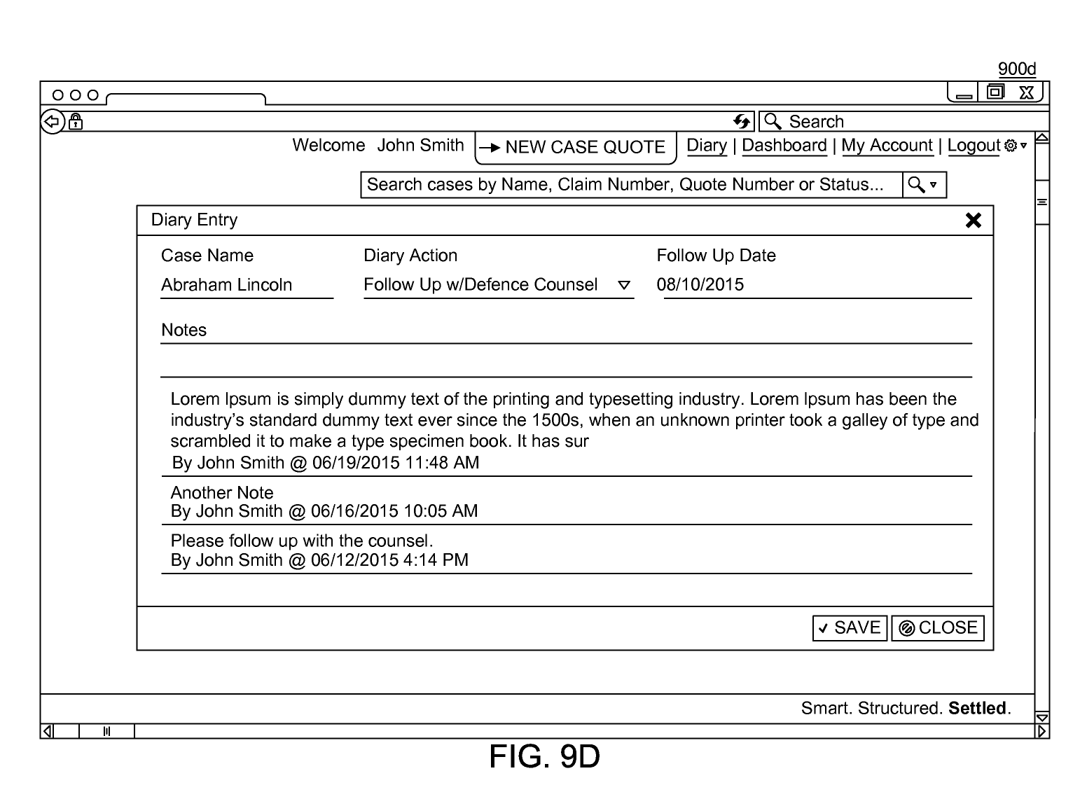

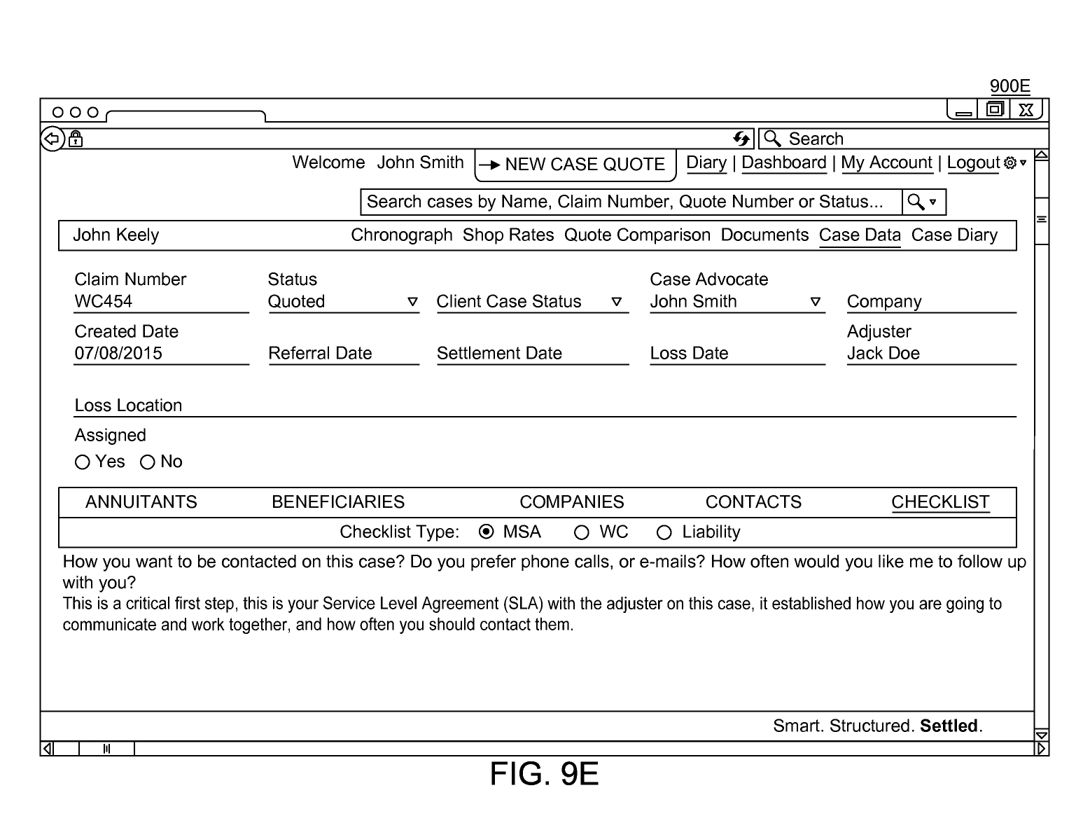

For example, if access at step 202 is successful (e.g., login credentials entered are verified), then, at step 208, the role and/or type of the user 201 is determined. For example, at step 208, a determination is made as to whether the user 201 is a claims professional (e.g., company system 107a), system administrator (e.g., system administrator 101a), and/or case advocate (e.g., case advocate system 101b). In some example embodiments, at step 208, it may also and/or alternatively be determined whether the user 201 is a case advocate, adjuster, or other participant. In some example implementations, access may be determined based on the type of user (e.g., participants and adjusters may have access similar to claim professional (e.g., company system); case advocate may have access similar to system administrator). The determination at 208 may be accomplished by checking the role, identifier, and/or other information associated with and/or stored, by the structured settlement provider system, in association with the login information input by the user 201. If it is determined at step 208 that the user 201 is a case advocate (e.g., customer advocate system 101b), a diary interface is presented to the user 201 at step 210. The diary interface (e.g., interface) is described in further detail below with reference to FIGS. 9A and 9B, respectively. If it is determined at step 208 that the user 201 is a system administrator (e.g., system administrator system 101a), the system administrator is provided with access to a diary at step 210, and/or to other interfaces, services, and/or processes provided by the structured settlement provider system 101, which are generally described herein throughout. In certain embodiments, the system administrator may access and/or be provided interfaces not available to others (e.g., not available to case advocates). For example, the system administrator (e.g., system administrator system 101a) may access an interface to view and/or modify multi-tenanted information and permissions associated therewith, as described in further detail below with reference to FIGS. 8A and 8B. If it is determined at step 208 that the user 201 is a claims professional (e.g., of a company corresponding to the companies' systems 107) and/or claims adjuster, a dashboard interface is presented to the user 201 at step 212. The dashboard interface is described in more detail below with reference to FIG. 9C.

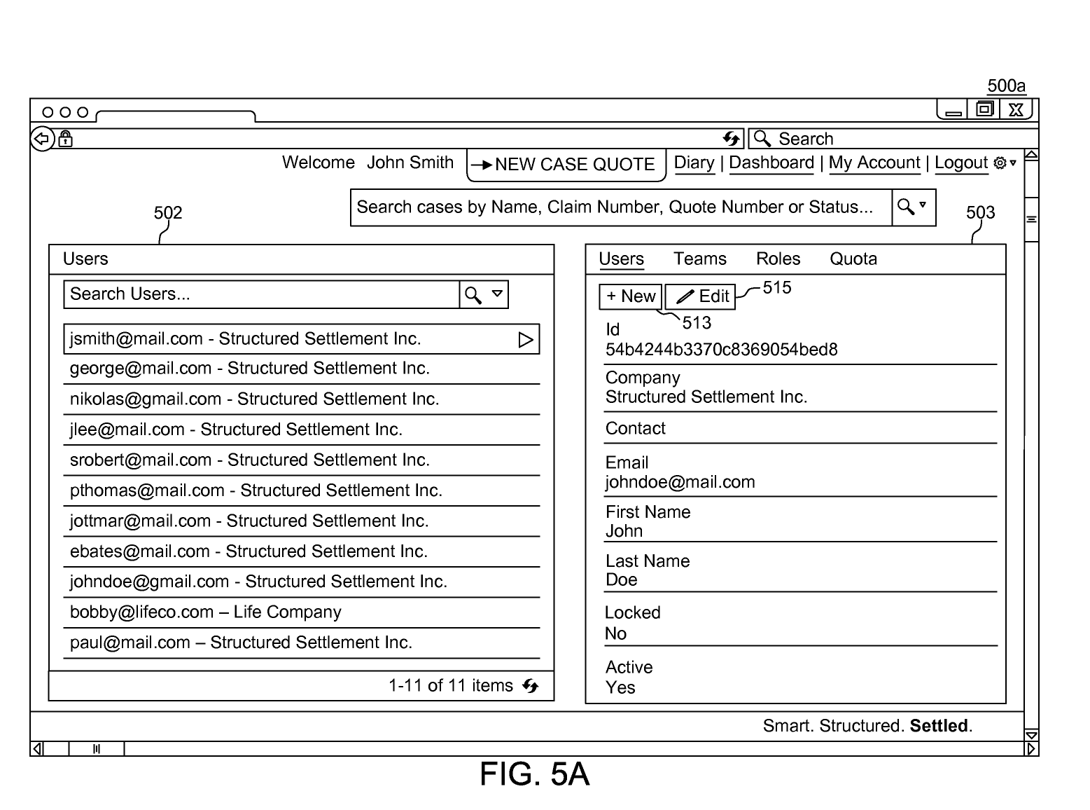

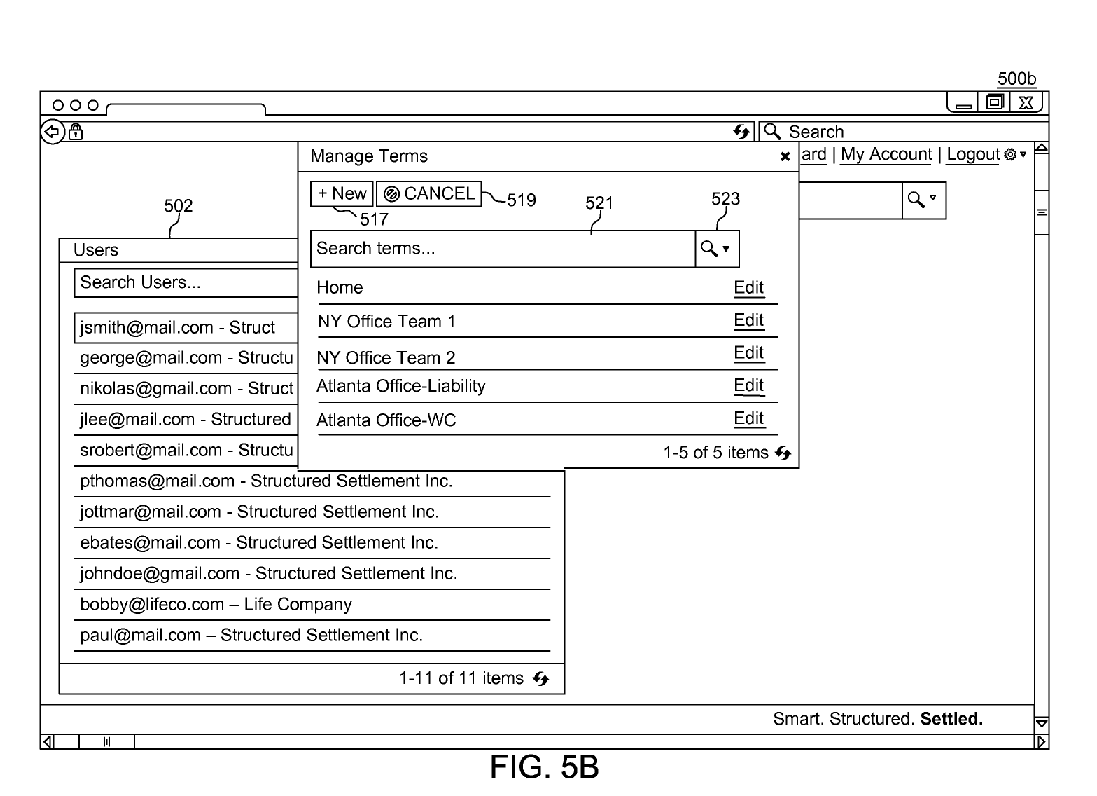

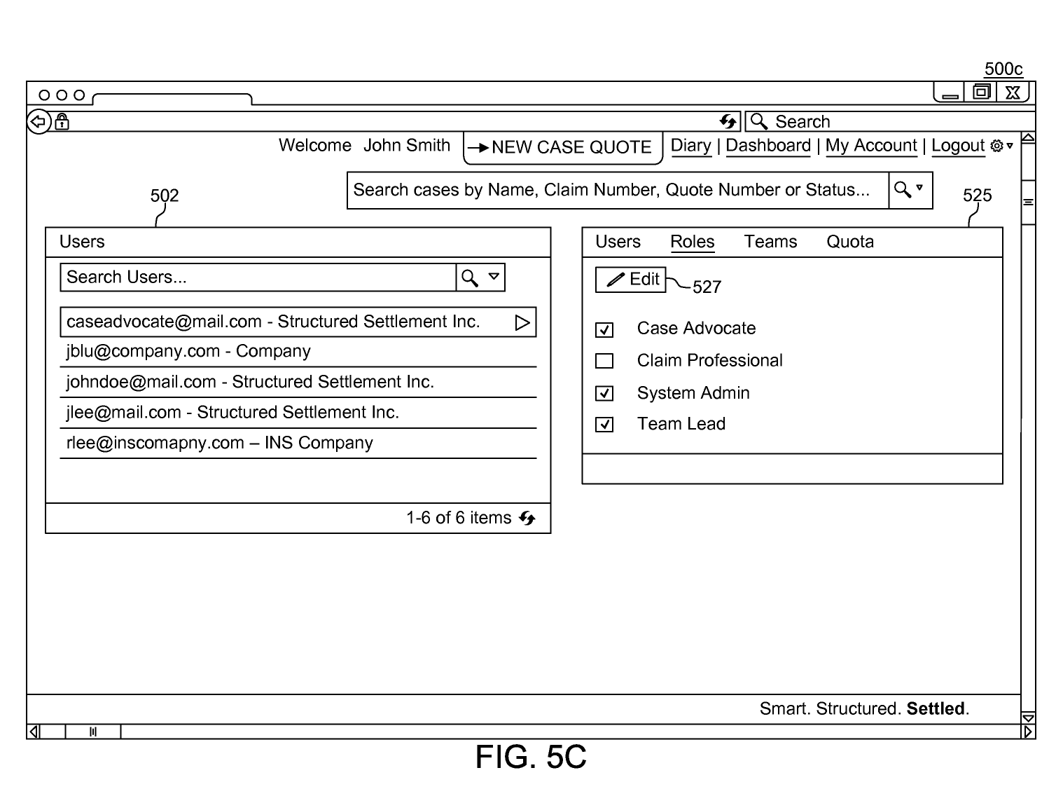

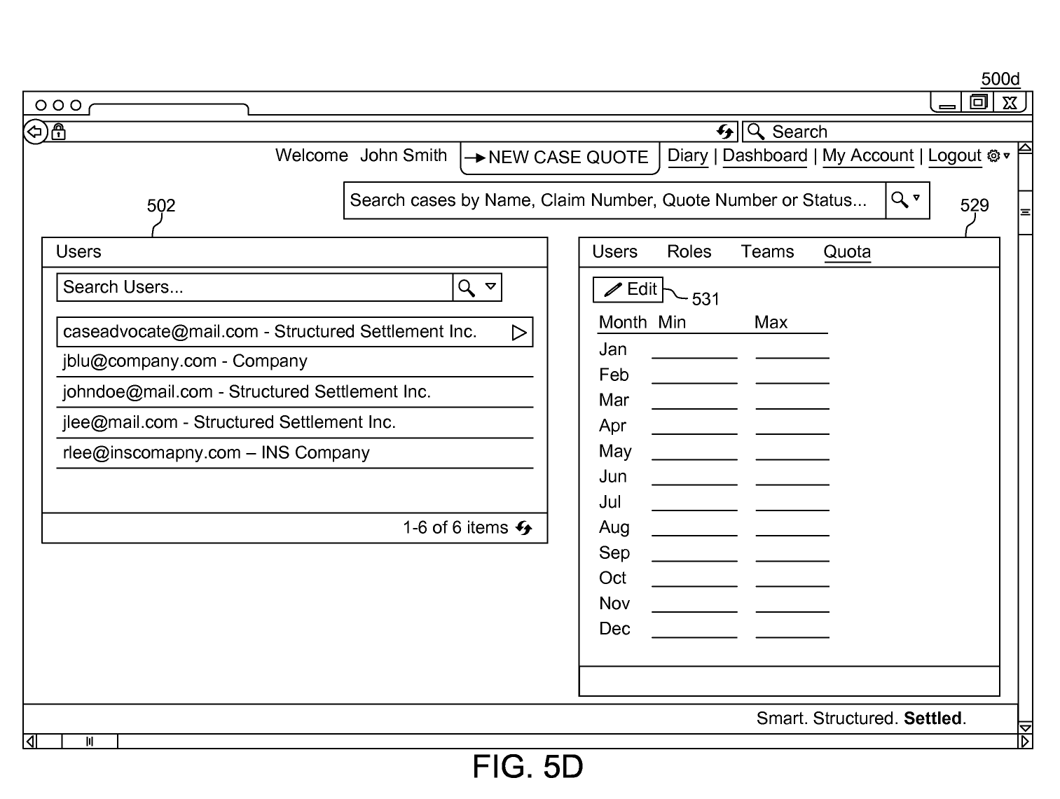

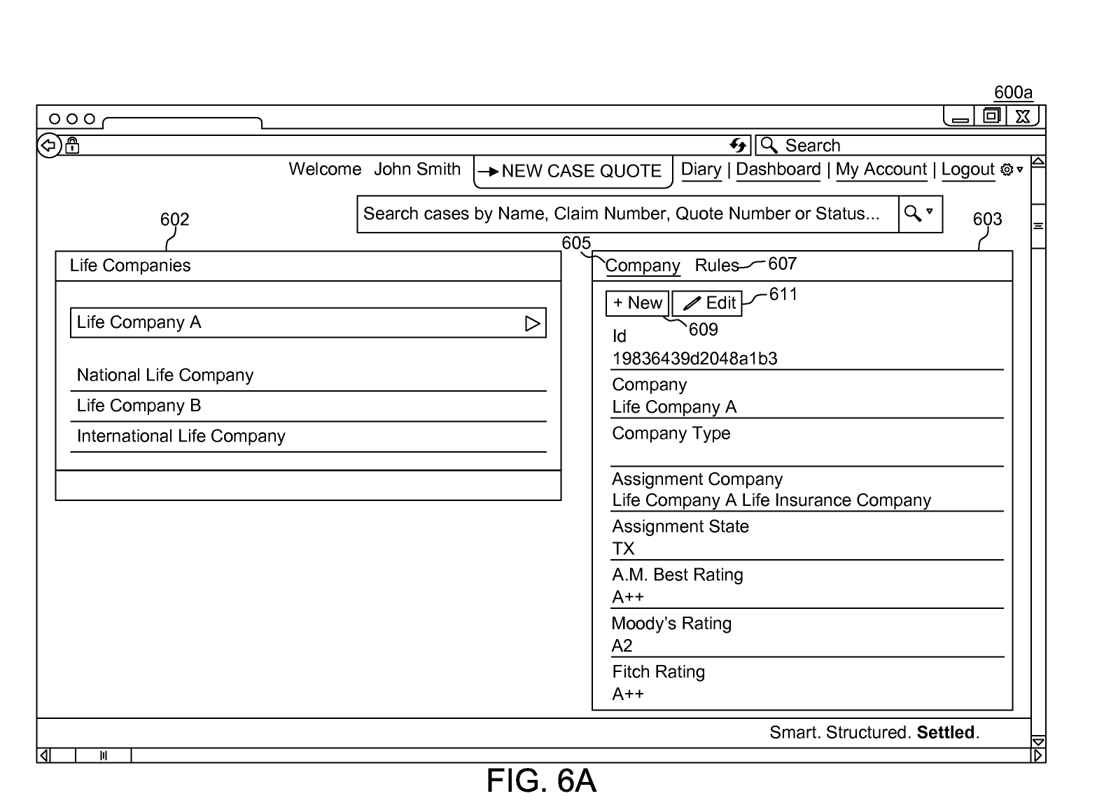

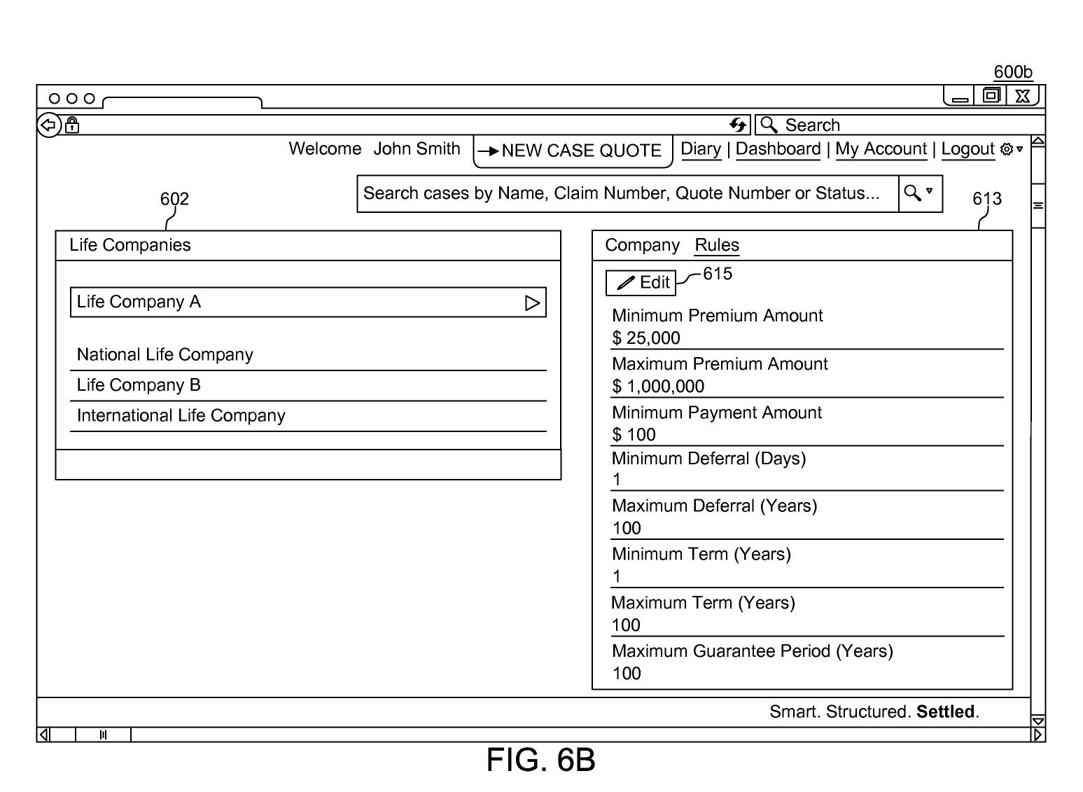

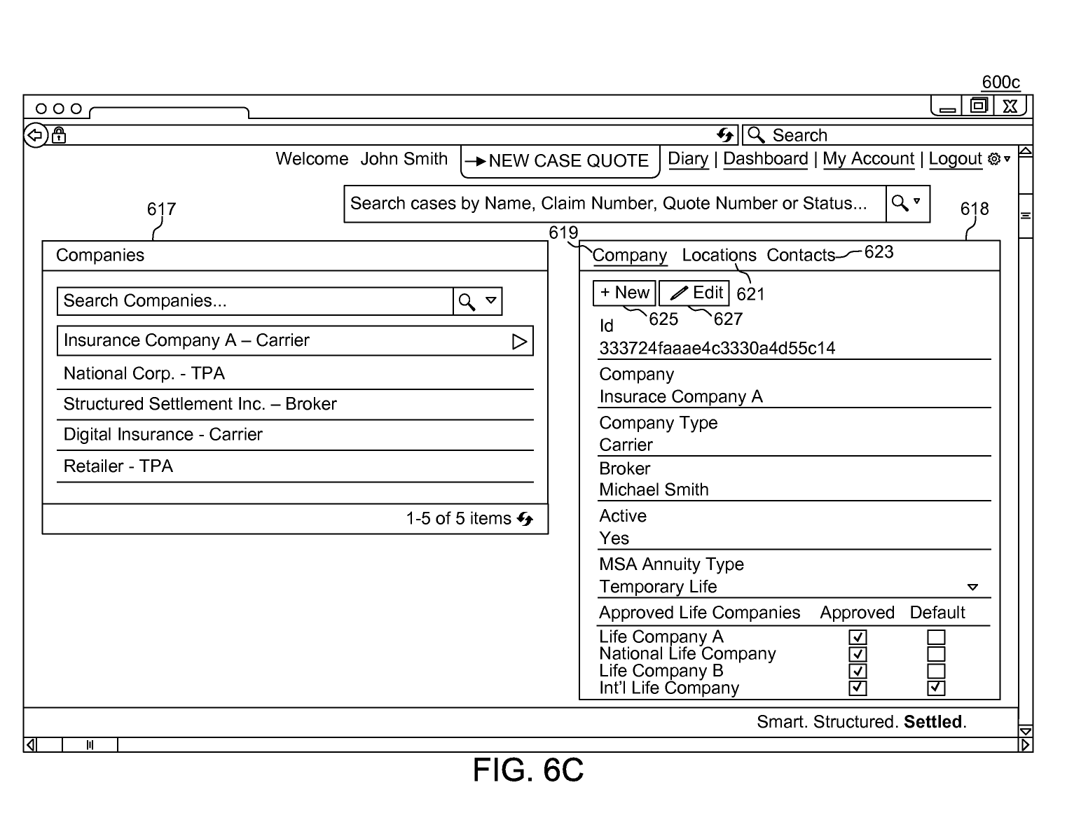

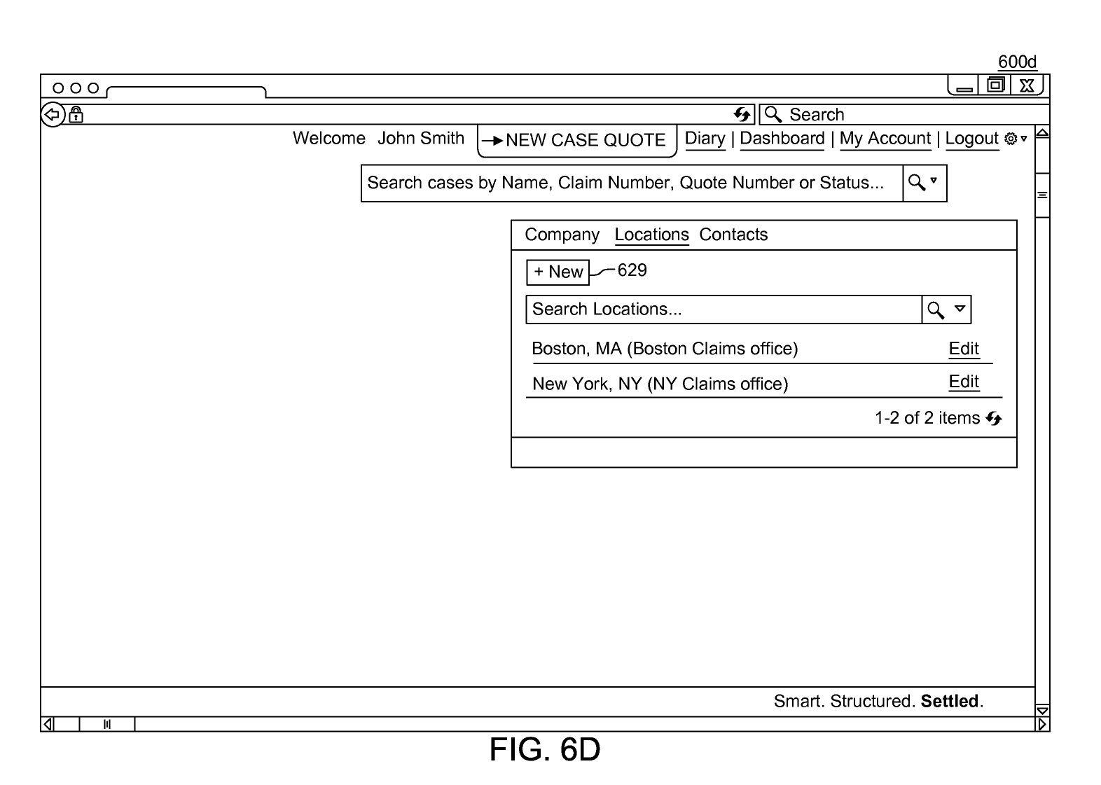

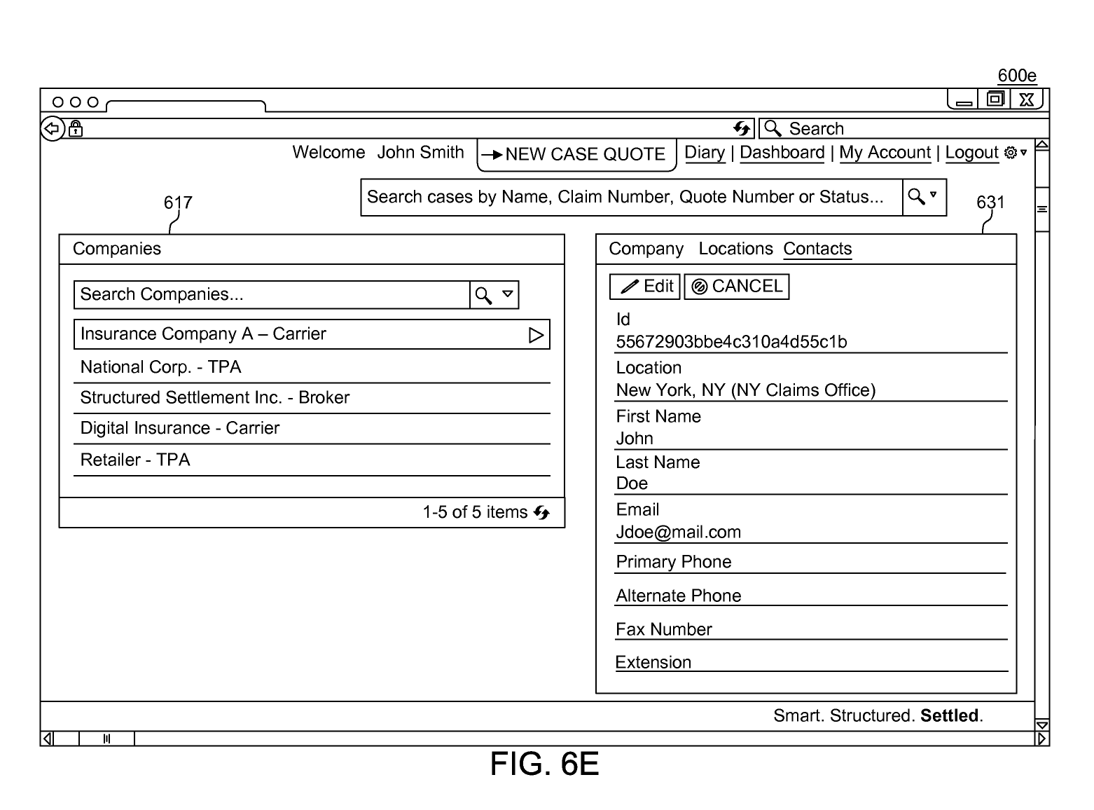

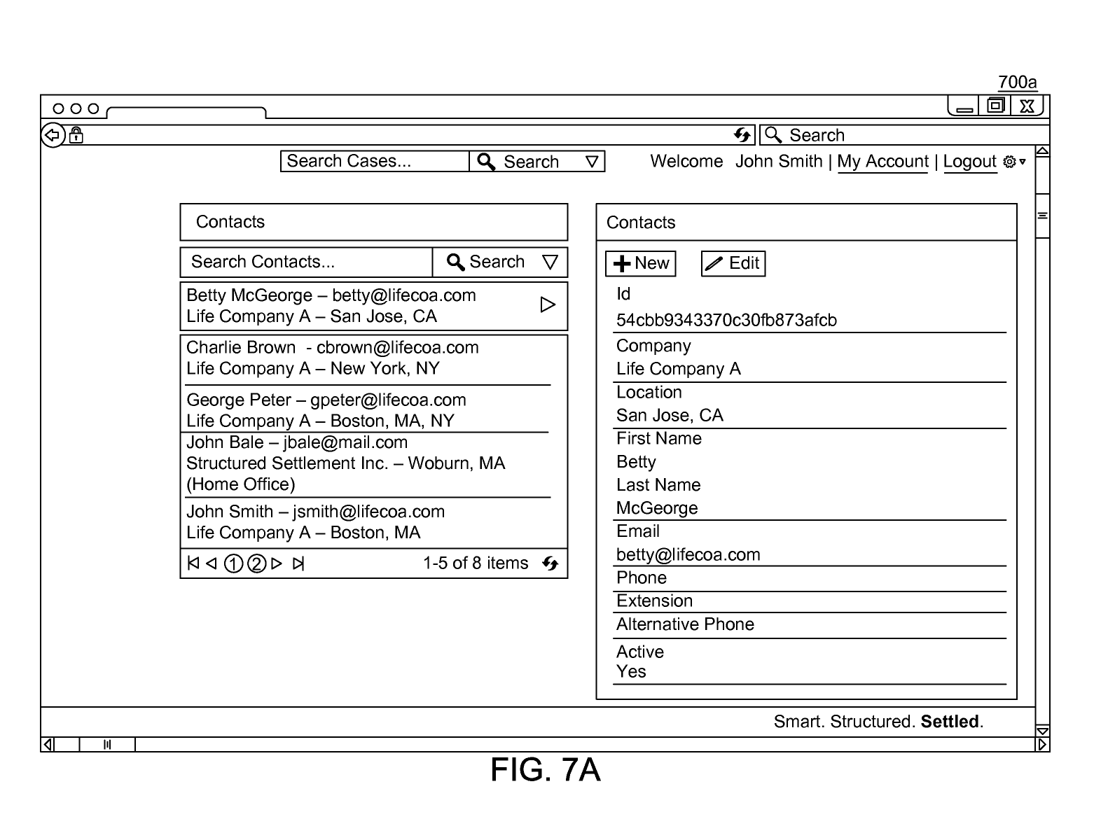

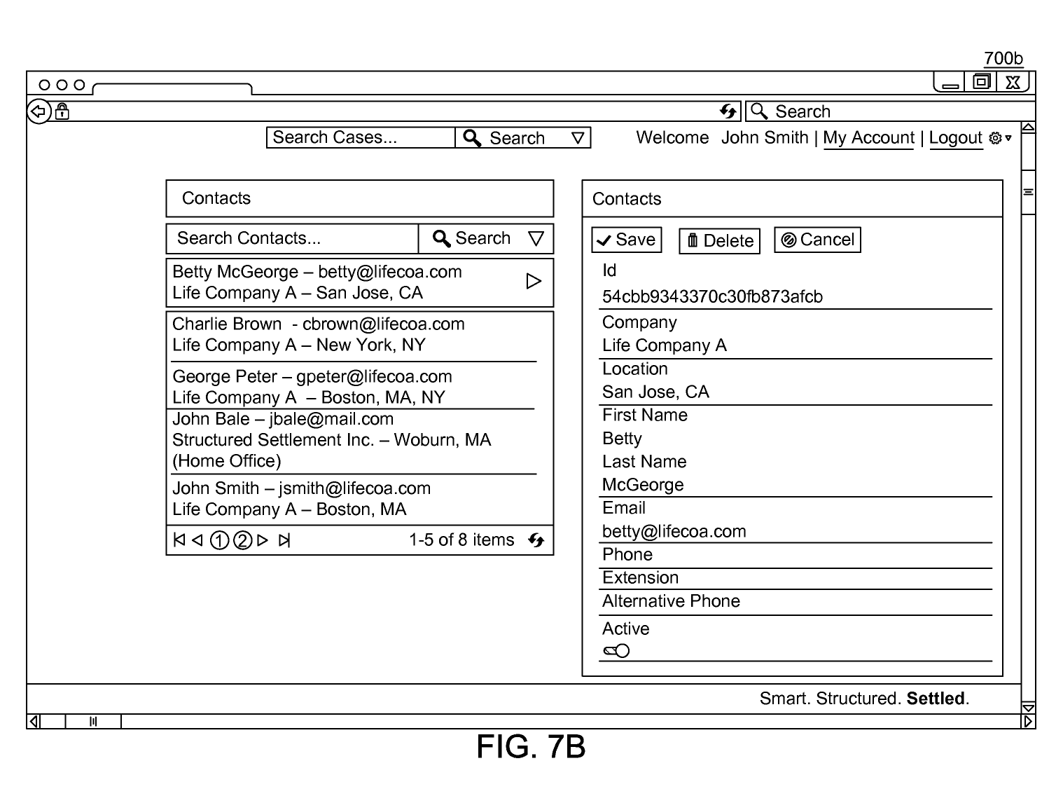

With reference to step 210, the diary interface provides options to the user 201 (e.g., case advocate and/or case advocate system). That is, via the diary interface presented at step 210, the user 201 may access, view, and/or modify, among other options, companies, contacts, and or users. If a user or a user option is selected via the diary interface presented at step 210, users interfaces are in turn presented to the user 201 at step 218. The users interfaces are described in further detail below with reference to FIGS. 5A, 5B, 5C, and 5D. If a company or a company option is selected via the diary interface presented at step 210, companies interfaces are in turn presented to the user 201 at step 214. The companies interfaces are described in further detail below with reference to FIGS. 6A, 6B, 6C, 6D, and 6E. If a contact or contacts option is selected via the diary interface presented at step 210, contacts interfaces are in turn presented to the user 201 at step 216. The contacts interfaces are described in further detail below with reference to FIGS. 7A and 7B.

Although not illustrated in FIG. 2, in certain embodiments, if it is determined at step 208 that the user 201 is a system administrator (e.g., system administrator system 101a), the user 201 is presented multi-tenanted information managing interfaces. The multi-tenanted interfaces may be used by the user 201 to access, view, and/or modify access granted to users (e.g., companies, companies' systems, claims professionals, claims adjusters, etc.) associated with the structured settlement provider system 101. The access may refer to permissions to read and/or write data (e.g., case data) stored in a multi-tenanted database or the like, in which each user, company or the like is referred to as a tenant. That is, tenants may be, for example, claims professionals (e.g., company system 107a) and/or system administrators (e.g., system administrator 101a). The tenants interfaces presented at step 220 are described in more detail below with reference to FIGS. 8A and 8B.

In certain embodiments, users (e.g., case advocates, system administrators, adjusters) may access a dashboard interface and/or interface. An example of a dashboard interface is presented in FIG. 9B. For example, with reference to step 212, the dashboard interface provides options to the user 201. Although not illustrated in FIG. 9B, the options may be buttons, links, and the like. For example, via the dashboard interface presented at step 212, the user 201 may, among other options, search cases (step 222), view cases (step 224), request quotes (step 226) and/or access accounts (e.g., account information) (step 228). If the option to view cases is selected via the dashboard interface presented at step 212, a search for a case is performed at step 222. Searching for cases is described in further detail below with reference to FIG. 9C. If the option to view cases is selected via the dashboard interface presented at step 212, all or a portion of cases associated and/or accessible by the user 201 are retrieved and/or presented at step 224. If the option to request a quote (e.g., new quote) is selected via the dashboard interface presented at step 212, a process to create a new quote is initiated at step 226. If the option to access accounts is selected via the dashboard interface presented at step 212, one or more interfaces for viewing and/or modifying account information are presented.

If the option to request a quote (e.g., new quote, step 226) is selected via the dashboard interface presented at step 212, the user 201 is in turn presented, at step 230, with options to (1) request a quote via a case advocate (e.g., via case advocate system, for example, telephonically), at step 232; or generate and/or create a quote (e.g., automatically) via a quote wizard (e.g., SmartQuote), at step 236. If the options to search (e.g., step 222) and/or view (step 224) cases are selected via the dashboard interface presented at step 212, the user 201 is in turn presented, at step 236, with a chronograph interface.

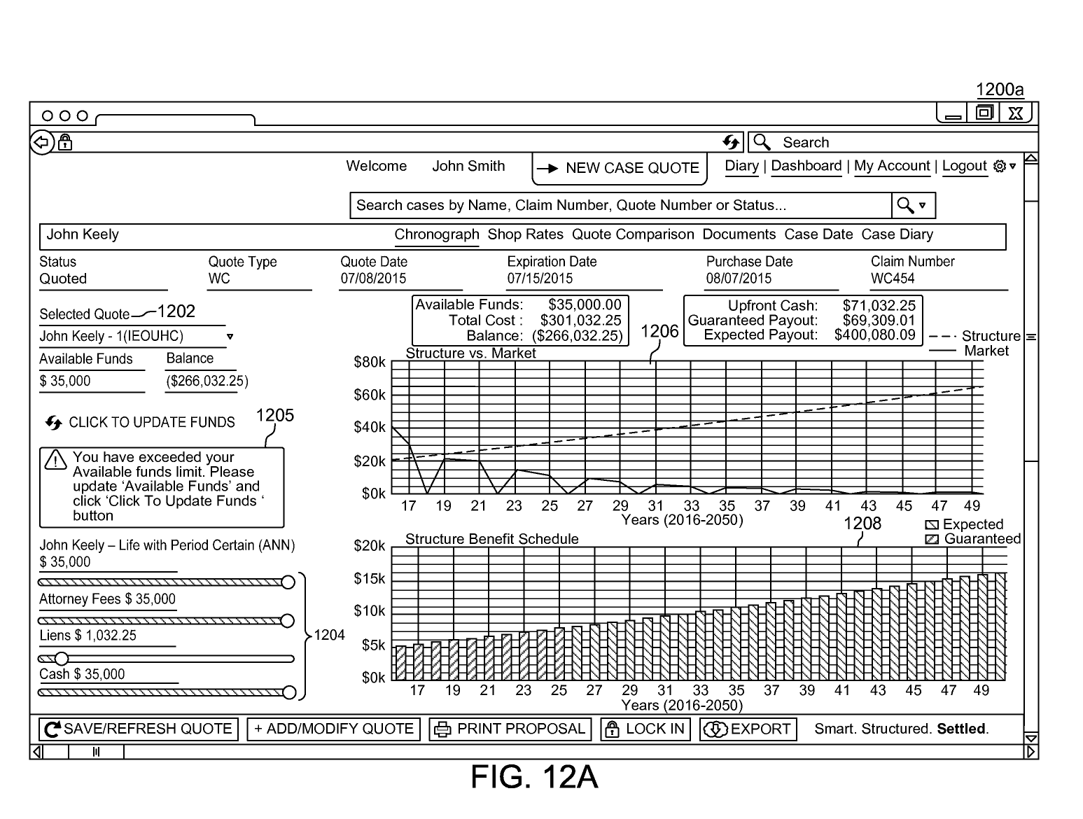

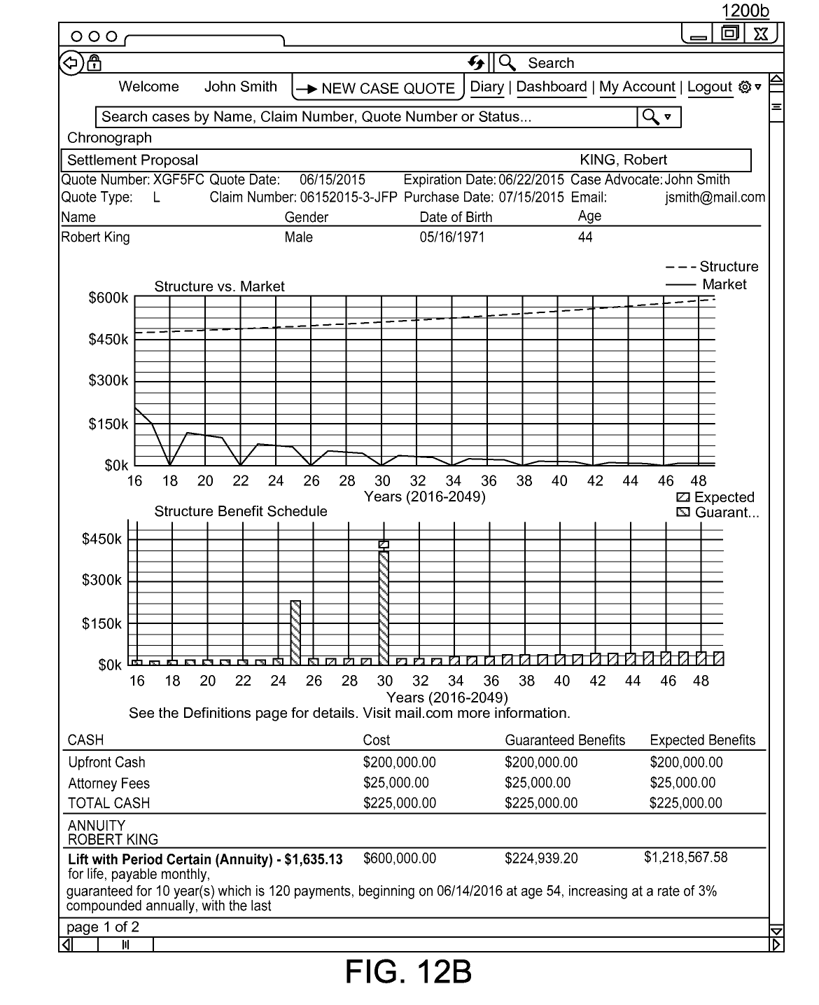

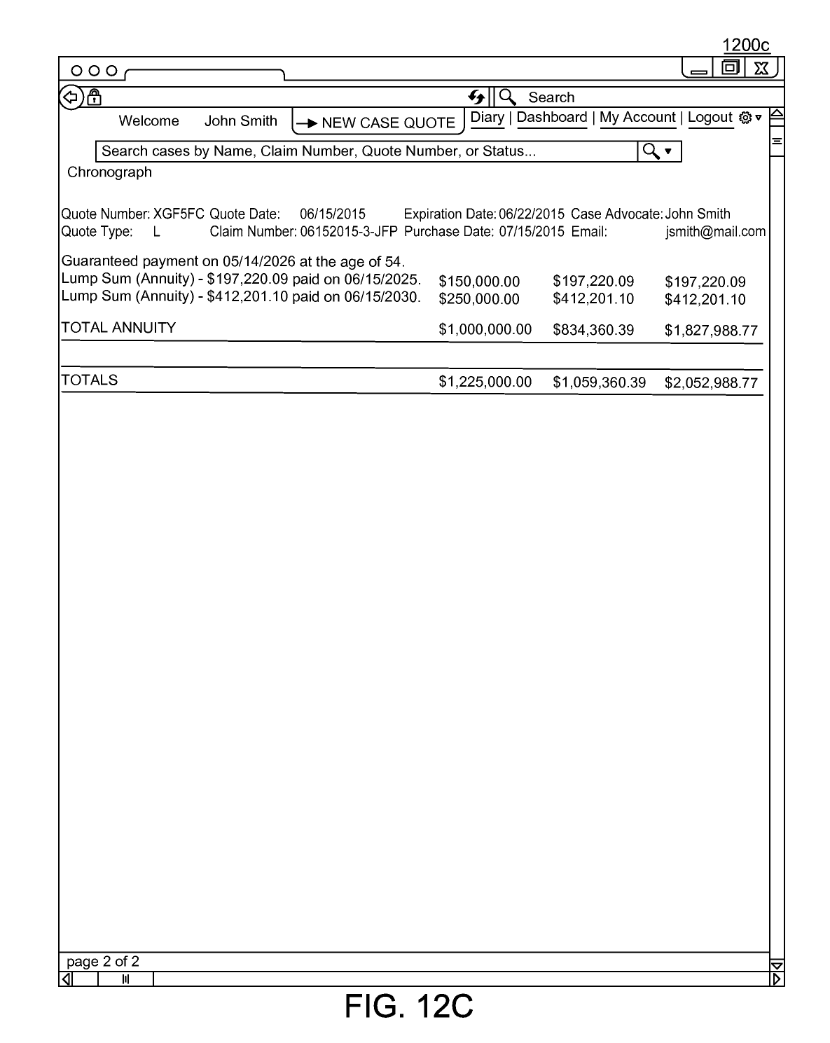

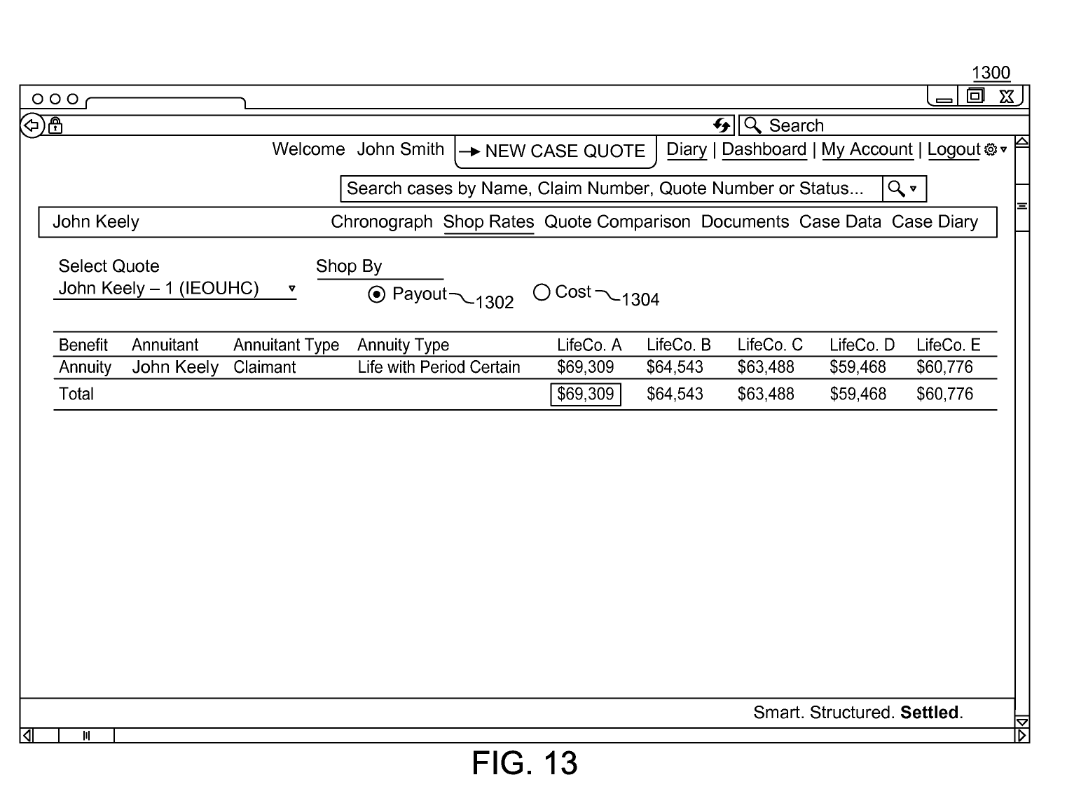

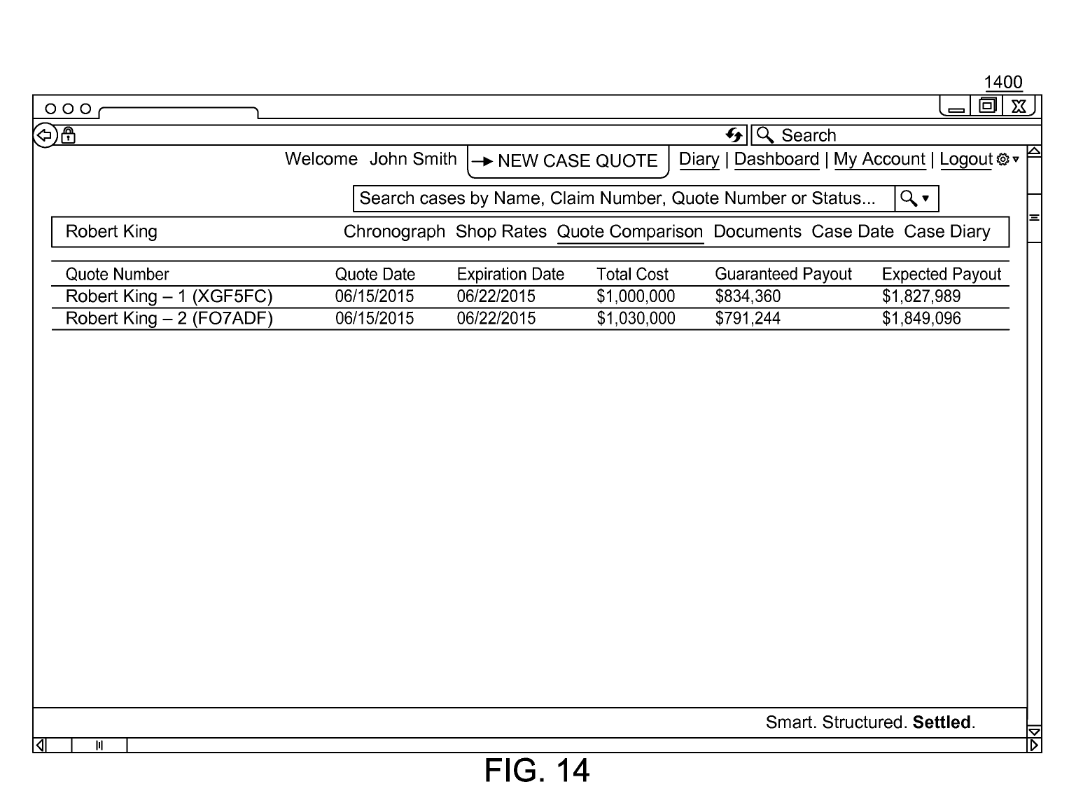

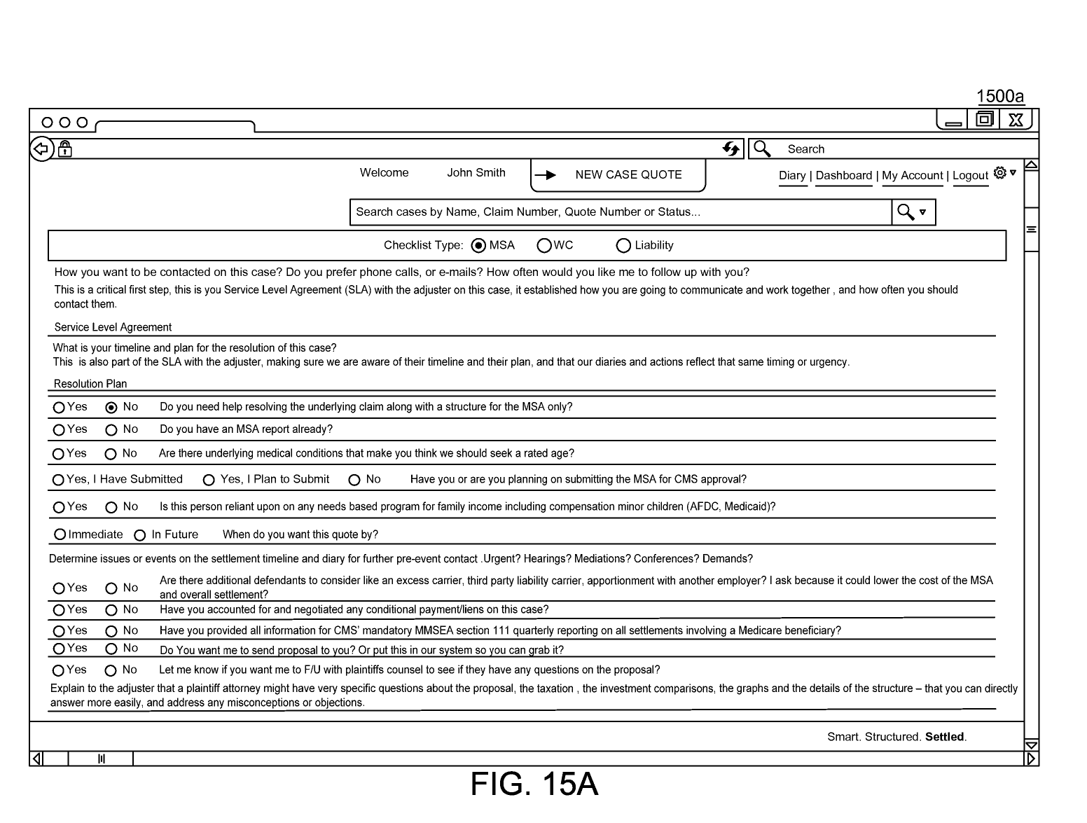

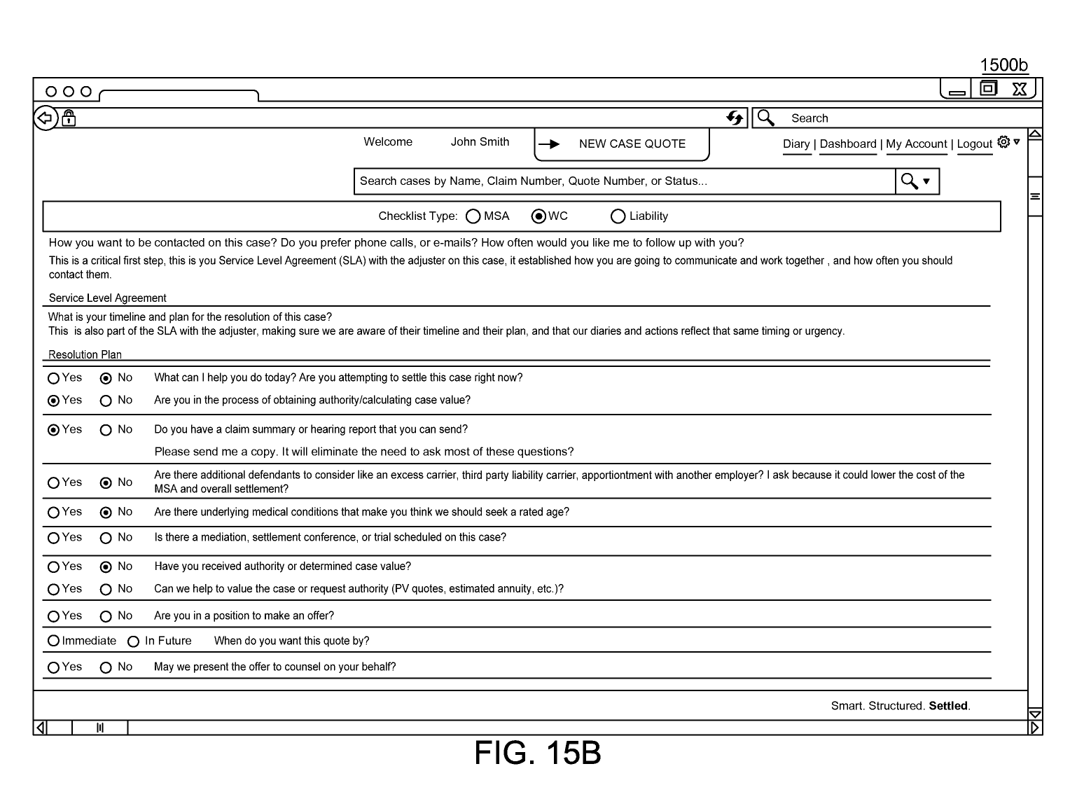

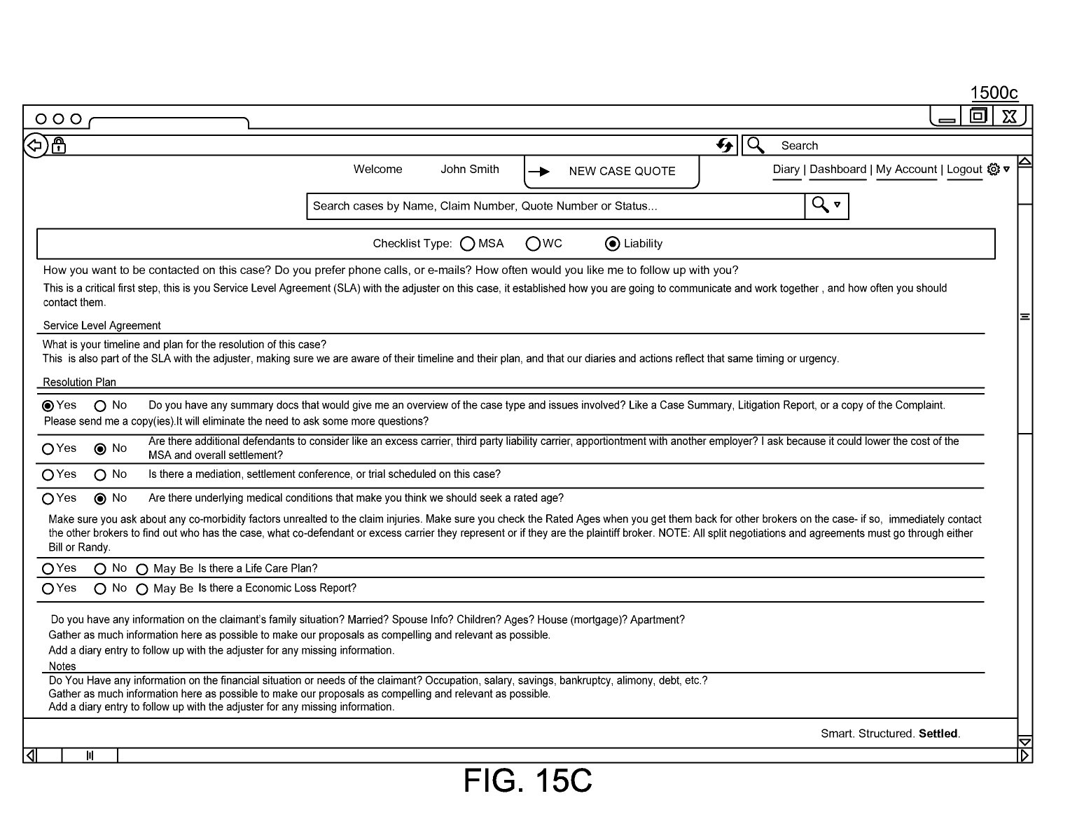

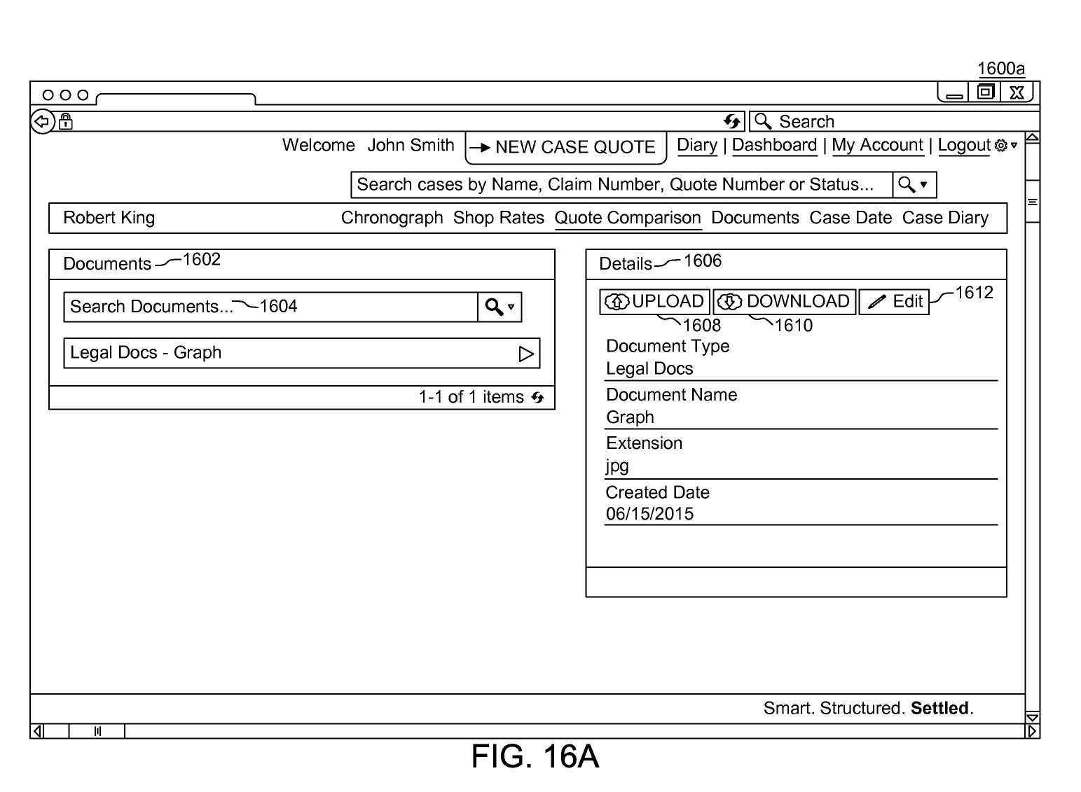

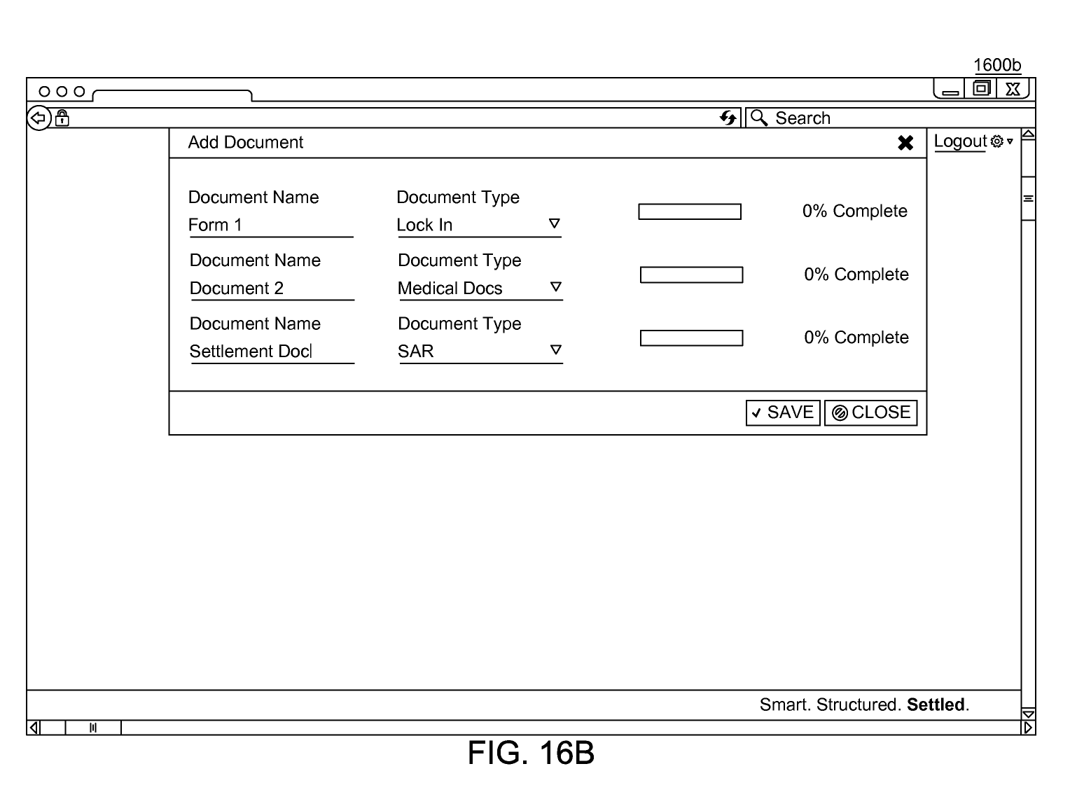

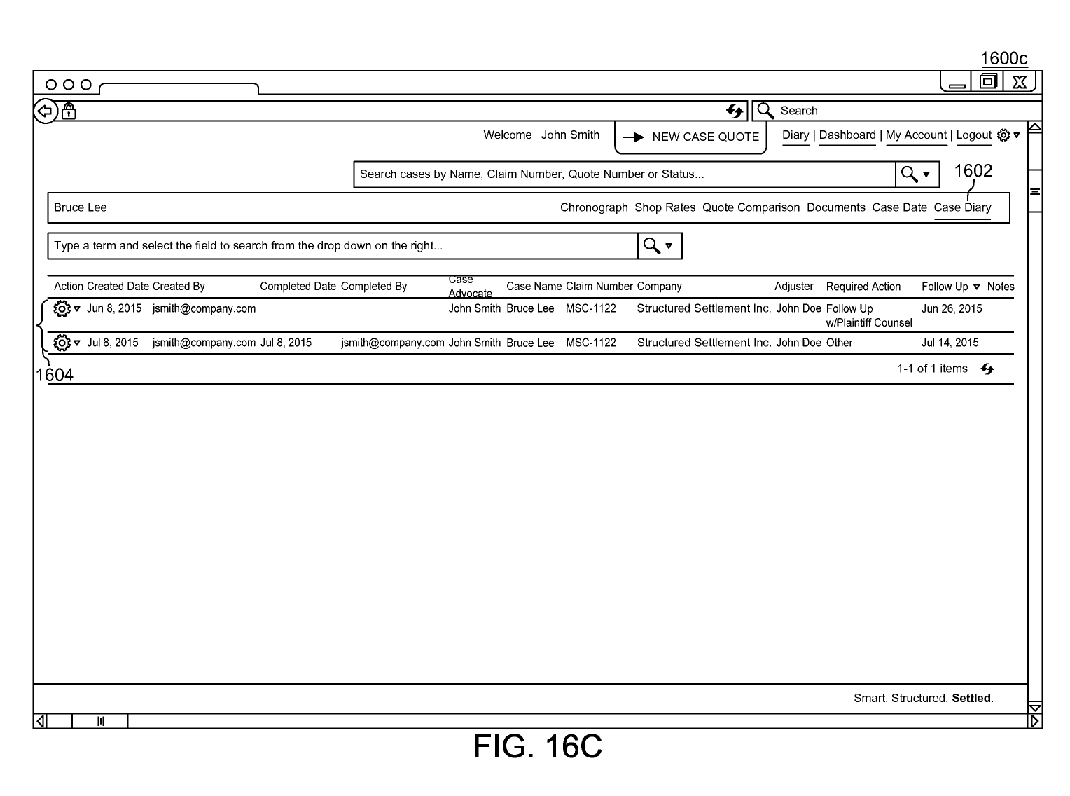

A chronograph interface (e.g., ChronoGraph) is described in further detail below with reference to FIGS. 12A-12C. In certain embodiments, the chronograph interface presented at step 236 is an interface or the like providing options to the user 201 (e.g., claims professional and/or company system). That is, via the chronograph interface presented at step 236, the user 201 may, among other options, shop for quote rates, access quotes history, access documents, access case data, and/or access case diaries. In some example implementations, the user 201 may modify quotes via the chronograph interface by comparing quotes and, in turn, selecting one of the compared quotes for modification. If the option to shop for quote rates is selected via the chronograph interface presented at step 236, a rate shopping interface is presented to the user 201 at step 238. The rate shopping interface is described in further detail below with reference to FIG. 13. If the option to compare quotes (e.g., access quotes history) is selected via the chronograph interface presented at step 236, access interfaces are presented to the user 201 at step 240. The access interfaces are described in further detail below with reference to FIG. 14. If the option to access documents is selected via the chronograph interface presented at step 236, document access functionalities (e.g., add documents, download documents) are provided to the user 201 at step 244. Accessing documents is described in further detail below with reference to FIG. 16. If the option to access case data is selected via the chronograph interface presented at step 236, case data interfaces are presented to the user 201 at step 246. In one example implementation, checklists are accessed via the case data option. Checklists are described in further detail below with reference to FIG. 15. If the option to view case diary information is selected via the chronograph interface presented at step 236, case diary interfaces are presented to the user at step 248.

FIG. 3 illustrates a log in interface 300 for accessing structured settlement services and/or functionality according to an exemplary embodiment. The log in interface 300 may be presented at a computing device (e.g., company system 107a, participant system 103a), for example, via a corresponding display and/or monitor. The log in interface is presented, for example, upon opening (e.g., executing) a software application (e.g., structured settlement software) and/or browsing, via web browser, to a web page (e.g., structured settlement web page). Successful access via the log in interface 300 may provide the computing device with access to structured settlement services and/or interfaces (e.g., case search, quote shopping).

The log in interface 300 includes a user name (e.g., email, email address) prompt, in which a unique user name identifier associated with an account is input. The log in interface 300 also includes a password prompt, in which a password (e.g., string of characters) associated with the user name is input. Moreover, the log in interface 300 includes a log in button and/or command 305. Selecting (e.g., clicking, tapping) the log in button and/or command 305 causes the user name and/or password entered in prompts 301 and 303, respectively, to be authenticated and/or verified. The authentication and/or verification may be performed by a structured settlement provider system (e.g., structured settlement provider system 101) or associated third party. It should be understood that any form of user name and/or password authentication and/or verification may be performed. It should also be understood that other log in mechanisms may be provided and/or presented by the log in interface 300. For example, the log in interface may use smart card authentication, location-based authentication, and/or biometrics authentication (e.g., face, eyes, fingerprints, voice, palmprint).

The log in interface 300 also includes a forgot password link (or the like) 307 (e.g., “Forgot Password?”). Selecting the forgot password link 307 causes a password reset process to be initiated. Resetting passwords is described in further detail below with reference to FIGS. 4A and 4B.

FIG. 4A illustrates an interface 400a for resetting a password according to an exemplary embodiment. In certain embodiments, the interface 400a is loaded or caused to be loaded (e.g., rendered, displayed, presented) by selecting a link, button or command indicating that a password has been forgotten (e.g., FIG. 3, forgot password link 307), for example, in a log in interface (e.g., FIG. 3, log in interface 300). The password resetting interface 400a includes an email prompt 401a, in which an email address for which its corresponding password is to be reset is entered. In certain embodiments, the e-mail in the e-mail prompt 401a is pre-populated after being previously entered in a log in interface. Once an e-mail address is entered in the prompt 401a, it may be transmitted for processing by selecting (e.g., clicking, tapping) a send e-mail (or message) button and/or command 403a. Alternatively, a close button and/or command 405a may be selected (e.g., clicked, tapped) to cancel the password resetting process. It should be understood that other password resetting mechanisms may be provided and/or presented by the password resetting interface 400a. For example, the password resetting interface 400a can employ security question and answer mechanisms to reset the password.

FIG. 4B illustrates an interface 400b for managing an account according to an exemplary embodiment. The account management interface 400b may be used, for example, to change a password (e.g., once a user is logged into the account and/or has been verified via an e-mail link). For example, the account management interface 400b includes a log in indication 401b, which includes information indicating whether a user is logged in (e.g., “Welcome”) and, in certain embodiments, also includes the name of the logged in user. For example, the account management interface 400b indicates that a user “John Smith” is logged into the system.

The account management interface 400b includes panels (e.g., sections, portions, panes, widgets), including a “Reset Password” panel 402b and an “Update Security Questions” panel 409b. A widget may be an application or the like that is programmed to perform particular functions. In some example implementations, widgets are executed via Web pages. The panel 402b may be used to modify a password associated with an account. The panel 402b includes a password prompt 403b, in which a user's current password (e.g., the password being changed and/or reset) is entered. The panel 402b also includes new password and confirm new password prompts 404b and 405b, respectively, in which a new matching password is to be entered. The password may be successfully modified when the password entered in the prompt 404b matches the password entered in the prompt 405b, and when both passwords meet predetermined password criteria displayed in the panel 402b. In certain embodiments, the predetermined password criteria may include an indication (e.g., “x” or check mark) indicating whether or not the passwords meets certain criterion. In certain embodiments, the criteria is the best practices for safeguarding access to accounts (e.g, resetting passwords). The panel 402b includes a button and/or command 407b (e.g., “Update”), which, when selected, causes the modification of the passwords to be processed.

The panel 409b of account management interface 400b may be used to update security questions and/or answers associated with the account. The panel 409b includes one or more security questions and corresponding answers. The answers to the security questions may be modified via the panel 401b. In certain embodiments, the security questions may also be modified. The panel 409b includes a button and/or command 411b (e.g., “Update”), which, when selected, causes the modification of the security questions and/or answers to be processed. More specifically, panel 409b includes a menu and/or drop down with a first security question (e.g., “Security Question 1”) and a menu and/or drop down with a second security question (e.g., “Security Question 2”). The answers to those questions are stored and, in turn, used to validate users attempting to access and/or modify an account.

FIG. 5A illustrates an interface 500a for managing users' information according to an exemplary embodiment. The user management interface 500a may be used, for example, to access a list of users, view user information, modify user information, and add user information. The user management interface 500a includes panels, including a “Users” panel 502 and an information panel 503.

The panel 502, In certain embodiments, includes a list of a portion or all users (e.g., user e-mails, user names) associated with one or more of a structured settlement provider, the entity (e.g., company, life company, etc.) with which each user is associated, and the like. The panel 502 may also include a search box, in which user information (e.g., user name, user e-mail) may be input to perform a search or query for matching or partially matching users. In certain embodiments, selecting a user in the panel 502 causes the user name to be highlighted in the panel 502, and causes corresponding user information to be displayed (e.g., retrieved, output) in the panel 503.

The panel 503 includes tabs (e.g., links) including “User” 505, “Teams” 507, “Roles” 509, and “Quota” 511. When the “User” tab 505 is selected, user information is displayed in the panel 503. User teams and roles may be used to control and/or limit what each user may see and/or do in a structured settlement management system. For example, teams and roles define what interfaces, contents, cases, and the like, each user is allowed to see and/or access.

User information may include a user identifier, company, e-mail, first name, last name, locked, and/or active. The “locked” field indicates whether the user's account has been locked, for example, due to exceeding a maximum number (e.g., 5) of failed log ins (e.g., attempts). In some example implementations, if an account becomes locked, a user is notified via a pop up window, message on the log in screen, or the like. The panel 503 also has buttons, including a “New” button 513, and an “Edit” button 515. Selecting (e.g., clicking, tapping) the “New” button 513 causes a prompt to be displayed to create a new user to add to the list of users. Selecting the “Edit” button 515 causes a prompt (e.g., updated panel, panel 503) to be displayed to edit the user information. Editing user information is described in further detail below with reference to FIG. 5D.

FIG. 5B illustrates an interface 500b for managing user information according to an exemplary embodiment. The interface 500b may be displayed, for example, when an option (e.g. link) is selected in a user management interface (e.g., 500a) or a user information panel (e.g., 503). The interface 500b illustrates the teams with which users of the system (e.g, user 201) are associated. For example, in FIG. 5B, the selected user is associated with 5 teams: “Home,” “NY Office Team 1,” “NY Office Team 2,” “Atlanta Office-Liability,” and “Atlanta Office-WC.” The interface 500b also allows new teams to be created and/or associated with the selected user by selecting a “New” button 517, or cancel the management of the teams by selecting a “Cancel” button 519. In certain embodiments, the user uses a search bar 521 to input team information to perform a query. In turn, selecting the search button 523 causes the system to look for teams with which the user is associated or would like to be associated. In certain embodiments, a user selects an “Edit” link or button corresponding to a team, which causes options to be presented to modify the team information and/or associations.

FIG. 5C illustrates an interface 500c for managing users' information according to an exemplary embodiment. The users' management interface 500c may be used, for example, to view and/or modify roles assigned to the user selected in the panel 502. In certain embodiments, a roles panel 525 is caused to be populated, displayed or the like when a “Roles” link is selected. The information displayed in the roles panel includes, for example, each role with which the user selected (highlighted) in panel 502 is associated. As shown in FIG. 500c, the selected user is associated with one of four possible roles (e.g., case advocate, claim professional, system administrator, team lead). An “Edit” button 527 may be selected to change (e.g., check) the roles with which the user is associated. In certain embodiments, modifying roles associated with a user causes the user's permissions for the user within the system to be modified. That is, if a user is assigned a “Team Lead” role, the user may also be granted management or supervisory rights, or the like. In some example embodiments, a user may have or be associated with multiple roles (e.g., team lead and case advocate).

FIG. 5D illustrates an interface 500d for managing users' information according to an exemplary embodiment. The users' management interface 500d may be used, for example, to view and/or modify quotas associated with the user selected in the panel 502. In certain embodiments, a quota refers to a maximum, minimum, and/or range of quotes given, pending, locked in, and/or settled. For example, panel 529 illustrates minimum and maximum quotas for each month of the year, specifying the number of quotes which are expected to be made by the user selected in the panel 502. Selecting the “Edit” button 531 allows the quota information for the selected user to be input and/or modified. By virtue of this feature, it is possible to track each users' progress relative to an assigned or predetermined quota (e.g., how many quotes have been settled by a user-case advocate).

FIG. 6A illustrates an interface 600a for managing life company information according to an exemplary embodiment. A structured settlement company may be a broker, seller or the like associated with, contracted and/or appointed by a life company. The structured settlement management company and/or system is responsible for purchasing corresponding structures from the life company on behalf of its customers (e.g., companies, participants). In certain embodiments, a life company may be a property and casualty insurance carrier, third party administrators (TPA), managing general agent (MGA), a self-insured person or entity, or another type of insurance company or insurance service provider.

The company management interface 600a may be used, for example, to access a list of life companies (e.g., life insurance companies or “Life Companies”), view their corresponding information, modify their information, and add new life companies. The life company management interface 600a includes panels (e.g., widgets, panes, sections), including a “Life Companies” panel 602 and an information panel 603.

The panel 602, in certain embodiments, includes a list of a portion or all life companies (e.g., life company names) associated with a structured settlement provider. Selecting a life company in the panel 602 causes the name of the life company to be highlighted in panel 602, and also causes corresponding information to be displayed (e.g., retrieved, output) in the panel 603.

The panel 603 has tabs (e.g., links) including “Company” 605 (e.g., life company) and “Rules” 607. When the “Company” tab 605 is selected (e.g., clicked, tapped), corresponding life company information is retrieved and/or displayed in the panel 603. Life company information may include a life company identifier, a life company name, a life company type, an assignment company, an assignment state and one or more ratings (e.g., A.M. Best Rating, Moody's Rating, Fitch Rating). The panel 603 also has buttons, including a “New” button 609 and an “Edit” button 611. Selecting (e.g., clicking, tapping) the “New” button 609 causes a prompt to be displayed to create a new life company to add to the life company list managed by the structured settlement provider. Selecting the “Edit” button 611 causes a prompt (e.g., updated panel, panel 603) to be displayed to edit the life company information.

FIG. 6B illustrates an interface 600b for managing life company information according to an exemplary embodiment. The interface 600b may be displayed, for example, when a rules option (e.g., link) is selected in a life company management interface (e.g., 600a) or a life company information panel (e.g., 603). The interface 600b illustrates the rules with which each life company is associated. In certain embodiments, the rules are underwriting rules that are used in a rating process to validate the rule against data inputs, to ensure compliance with the underwriting rules.

For example, in FIG. 6B, the selected life company is assigned and/or required to abide by a number of rules, shown in the panel 613. Examples of the rules with which a company may be associated include but are not limited to a minimum premium amount, maximum premium amount, minimum payment amount, minimum deferral amount in days, maximum deferral amount in years, minimum term in years, maximum term in years, and maximum guarantee period. Using these rules, life companies avoid receiving quotes or requests for quotes that do not conform within their minimum standards (e.g., rules). An “Edit” button 615 may be selected to change the rules with which a life company is associated.

FIG. 6C illustrates an interface 600c for managing company information according to an exemplary embodiment. The company management interface 600c may be used, for example, to access a list of companies (e.g., corresponding to company systems 107; customers), view company information, modify company information, and add companies. The company management interface 600c includes panels (e.g., widgets, panes, sections), including a “Companies” panel 617 and an information panel 618.

The panel 617, in certain embodiments, includes a list of a portion or all companies (e.g., customers, defense firms) associated with a structured settlement provider. Selecting a company in the panel 617 causes the name of the company to be highlighted in panel 617, and also causes corresponding information to be displayed (e.g., retrieved, output) in the panel 618. The panel may also include a search box, in which company information (e.g., company name) may be input to perform a search or query for matching (or partially matching) companies.

The panel 618 includes tabs (e.g., links) including “Company” 619, “Locations” 621, and “Contacts” 623. When the “Company” tab 619 is selected (e.g., clicked, tapped), company information is retrieved and/or displayed in the panel 618. Company information may include a company identifier, a company name, a company type, a broker or case advocate name (e.g., from the structured settlement management company), an indication of whether the company is active, an indication of MSA annuity type, and associated approved life companies including an indication of whether they are approved and/or the default life company. The panel 618 also has buttons, including a “New” button 625 and an “Edit” button 627. Selecting (e.g., clicking, tapping) the “New” button 625 causes a prompt to be displayed to create a new company to add to the company list. Selecting the “Edit” button 627 causes a prompt (e.g., updated panel, panel 618) to be displayed to edit the company information.

FIG. 6D illustrates an interface 600d for managing company information according to an exemplary embodiment. The interface 600d may be displayed, for example, when locations option (e.g., link) is selected in a company management interface (e.g., 600c) or a company information panel (e.g., 618). The interface 600d illustrates locations at which the selected company (e.g., selected in panel 617 of FIG. 6C) is located and/or has offices. For example, in FIG. 6D, the selected company includes a Boston, Mass. office and a New York, N.Y. office. The interface 600d includes a “New” button 629 that when selected (e.g., pressed, clicked, tapped), causes one or more prompts to be displayed to enter new office information corresponding to the selected company. In certain embodiments, the interface 600d includes a search bar or section, where names of cities, states, and/or offices (e.g., locations) can be entered to perform a query or search.

FIG. 6E illustrates an interface 600e for managing company information according to an exemplary embodiment. The interface 600e may be displayed, for example, when a contacts option (e.g., link) is selected in a company management interface (e.g., 600c) or a company information panel (e.g., 618). The interface 600e illustrates company information and/or information of contacts at the company. An individual contact may or may not be a user of the structured settlement management system. More specifically, company contact information may be shown in a contacts panel 631. The company contact information may include a company identifier, location of the company, name of an individual (e.g., first and last name), an e-mail for the individual, as well as phone numbers (e.g., primary, alternates, fax number, extension).

FIGS. 7A and 7B illustrate interfaces 700a and 700b, respectively, for managing contact information associated with a structured settlement provider. The contacts may be, for example, individuals employed by a company (e.g., customer companies, life companies, and the like). As shown in interfaces 700a and 700b, each of the interfaces includes a listing of contact people, as well as a contact information panel which is populated with corresponding information when an individual contact is selected. The contact information may be edited via an “Edit” button, and new contacts may be added via a “New” button. In certain embodiments, the contact information may include a contact identifier, company, location (e.g., city and state), first name, last name, e-mail, phone number extension, alternative phone, and an indication of whether or not the contact is active.

FIGS. 8A and 8B illustrate interfaces 800a and 800b, respectively, for managing tenant information associated with a structured settlement provider. As described above in more detail with reference to FIG. 1, tenants may be, for example, claims professionals (e.g., company system 107a), companies, and/or system administrators (e.g., system administrator 101a). As shown in interfaces 800a and 800b, each of the interfaces includes a listing of tenants, as well as a tenant information panel (e.g., tenant details) which is populated with corresponding information when an individual tenant is selected. The tenant information may be edited via an “Edit” button, and new tenants may be added via a “New” button. In certain embodiments, the tenant information may include a tenant identifier, name, host, port, name of associated database, and a user name for the tenant. A tenant (e.g., company) of a database allows users (e.g., claims professionals) associated with that tenant to have access to the database and information stored therein.

FIG. 9A illustrates a diary interface 900a for managing cases according to an exemplary embodiment. In certain embodiments, the diary interface 900a is the first interface that is displayed (e.g., rendered, caused to be displayed) when a user logs into a structured settlement management system. The diary interface may additionally or alternatively be accessed by selected (e.g., clicking, tapping) a diary link (e.g., option) 902.

Generally, diary interface 900a is used, for example, by a case advocate (via a corresponding case advocate system) to view, track and/or manage tasks and/or responsibilities and/or required actions (e.g., outstanding) associated to cases that the case advocate is assigned to, associated with and/or handling. Groups of information in a diary interface are referred to as diary (or case) entries. Diary entries are made up of diary entry data, which can be input and/or updated, to subsequently display in a diary interface 900a, by one or more of: manual entry via the diary entry interface shown in FIG. 9D by the case advocate system, retrieving case data (e.g., size, case components, and obtaining answers to checklist questions). Checklists are described in more detail below with reference to FIGS. 15A to 15C. In turn, diary entries can be edited, completed, archived and the like via the diary interface 900a.

All or a portion of the case data may be displayed in a corresponding row on a table or the like in diary interface 900a. For example, case entry 904 is a case which is associated with the user logged into the claim management system. In some instances, the user logged into the system may be the creator of the diary entry, the manager of the case associated with the diary entry, or the case advocate associated with the case. Examples of information associated with a diary entry and displayed in a diary interface 900a include: a date on which the diary entry was created; the name or e-mail of the creator of the diary entry, the name or e-mail of the case advocate associated with the diary entry; the name of the case; a claim number associated with the case; the name of the insurance company associated with the case; the name of the claim adjuster handling the case; an indication (e.g., notes) of what action, if any, is required and/or outstanding in the case; a date on which a follow up and/or action for the case is required, and any notes associated with the case of the diary entry. In certain embodiments, selecting (e.g., clicking, tapping, double clicking) one of the diary entries causes the diary entry to be loaded for viewing and/or editing via one or more prompts, as shown in FIG. 9D.

More specifically, each of the diary entries 904, 906, 908 and 910 is associated with corresponding case data, as shown in FIG. 9E. As shown in FIG. 9E, a diary entry accessed via the diary interface 900c includes case data such as a claim number, claim status, client case status, case advocate, company, date the claim was created, referral date, settlement date, loss date, corresponding adjuster, loss location, an indication of whether the claim has been assigned, and options to view checklists associated with the claim.

That is, each of the diary entries 904-910 displayed in the diary interface 9001 includes data that is created, modified, and/or maintained based on rules (described in more detail with reference to FIG. 6B), analysis of case data, and responses to checklists. Checklists are described in further detail below with reference to FIGS. 15A to 15C. That is, the entries that are displayed, the data that is displayed for each entry, and the access to the entries is calculated before presenting in the interface 900a.

In still another example implementation, notes associated with a diary entry are time and date stamped, so that access to those notes and/or addition of new notes is tracked. In fact, In certain embodiments, diary entries may not be edited. Required actions associated with a diary entry may be categorized. Moreover, when a case is closed, the diary entry corresponding to the case may be stored and/or archived for future use (e.g., audits, recordkeeping, etc.)

FIG. 9B illustrates a settlement dashboard 900b for managing structured settlements according to an exemplary embodiment. The settlement dashboard 900b may be an interface or the like, through which users (e.g., participants, claims professionals) can, among other options, view settlement information (e.g., metrics), view cases, search for cases, and/or request a new quotes. That is, the settlement dashboard 900b displays settlement information (e.g., metrics) associated with a logged in user. For example, if the user is a claims professional, the settlement dashboard 900 may display settlement information of cases associated with that claims professional. In certain embodiments, the settlement dashboard 900b is the first interface or interface that a user sees upon logging into the structured settlement management system. The settlement dashboard provides a high level view of the actual and expected performance of claims professionals, adjusters, teams, or offices associated with a structured settlement management company or system.

In certain embodiments, the settlement dashboard 900 displays a summary of the total number of cases distributed according to their status. More specifically, the settlement dashboard 900b illustrated in FIG. 9B displays the total number of cases quoted (902), pending (904), locked in (e.g., finalized, reserved) (906), awaiting (e.g., awaiting confirmation from one or more of the participants or companies) (908), and settled (910). These totals (e.g., 902-910) and others described with reference to FIG. 9 and displayed in the dashboard 900b may be filtered and/or restricted by or to a month-to-date, quarter-to-date, or year-to-date range, or by amount of settlement, location, insurance provider, and the like. In certain embodiments, a plus sign (‘+’) corresponding to the totals 902-910 causes the cases (or information thereof) that are used to calculate the corresponding total to be displayed.

The dashboard 900b includes a progress to date panel or widget 912, which displays month-to-date, quarter-to-date, and/or year-to-date totals and/or calculations of expected settlements, completed settlements, and percentage achieved. The expected settlements indicate how many settlements the user of the structured settlement management system is expected to settle based, for example, on the number of cases quoted, pending, locked in, and/or awaiting. The completed settlements indicates the number of settlements that are actually completed (e.g., settled). The percentage achieved indicates the ratio of cases which the user is expected to settle compared with those that are actually settled to date.

The dashboard 900b includes a savings to date panel or widget 914, which displays month-to-date, quarter-to-date, and/or year-to-date totals and/or calculations of savings for caseload and current savings per claim. That is, the savings per caseload indicates a total sum of resulting savings of all the cases in the user's caseload. The current savings per claim indicates and average of saving for each claim with which the user of the system is associated.

In certain embodiments, the settlement dashboard 900 includes a summary of the progress of the settlements (e.g., “Progress to Date”). The progress may be a calculation of the percentage (e.g., “% Achieved”) of the cases for which settlements have been completed (e.g., “Completed Settlements”) from the total number of expected settlements (e.g., settlements in progress; “Expected Settlements”). The progress (e.g., progress to date) may be displayed and/or represented graphically (rather than numerically), for example, using a color coded progress bar. The progress may be restricted by filtering the cases used in the progress calculations, by date range or other criteria.

The settlement dashboard may also include a summary of savings (e.g., “Savings to Date” 903) associated with the cases corresponding to the logged in user. The savings may include the total dollar amount of savings for all cases (e.g., “Savings for Caseload”), as well as a savings per claim (“Current Savings per Claim”). The total savings may be the sum, for all cases, of the difference between the cost paid for a financial instrument (e.g., annuity) in a finalized structure settlement (e.g., settled) and the cost of the next cheapest rate for the same financial instrument. For example, if the total cost of an annuity in a finalized structure settlement is $200,000, and the cost of the next lowest quoted rate is $250,000, the total savings for that case would be $50,000. The savings per claims may be the total savings, as described above, divided by the number of claims and/or structured settlements. That is, if the total savings for all cases is $500,000, and the user is associated with five finalized structured settlements and/or claims, the savings per claim would be $100,000.

Although not illustrated in FIG. 9B, the settlement dashboard may also include information and/or statistics regarding life companies (e.g., life company systems, insurance providers). For example, the information regarding life companies may include the percentage of times that a life company is used by the user (e.g., the fraction of structured settlements corresponding to the user that were completed using a particular life company). For example, the life company information may include the name of life company and a corresponding percentage of structured settlements and/or claims that that life company was the annuity seller (e.g., “4.02%”).

The settlement dashboard may include a search box 916, in which case information (e.g., last name, case number) may be input. In turn, the information input into the search box 916 is used to perform a search and/or query against stored case and/or claim information. The cases (and their corresponding case information) returned by the search and/or query may be displayed, as shown in more detail with reference to FIG. 9C.

In certain embodiments, the cases that are eligible to be used for the calculations and/or totals displayed in the settlements interface 900b may be selected and/or filtered by an adjuster or by a user with sufficient permissions based on the role and/or team assignment of the user.

FIG. 9C illustrates a case search interface 900c according to an exemplary embodiment. As discussed with reference to FIG. 9B, a user of a structured settlement management system may perform a search for cases via a settlement dashboard (e.g., 900b). The search may be performed using one or more of (e.g., not limited to) a case name, claim number, quote number, or status.

The results of a search (e.g., partial or full matches) are displayed in interface 900c. The search interface 900c displays case information for each result from the search, including status of the case, case name, quote number, claim number, date and/or time the case was last updated, and/or links to take actions on each case. The actions to be taken on a case may include opening up the case or creating a diary. Selecting (e.g., clicking) the link to open a case causes a window, panel, widget or the like to be opened (e.g., rendered, displayed) illustrating case information. On the other hand, selecting the link to create a diary causes the selected case to be added to the diary interface, which is described above in more detail with reference to FIG. 9A.

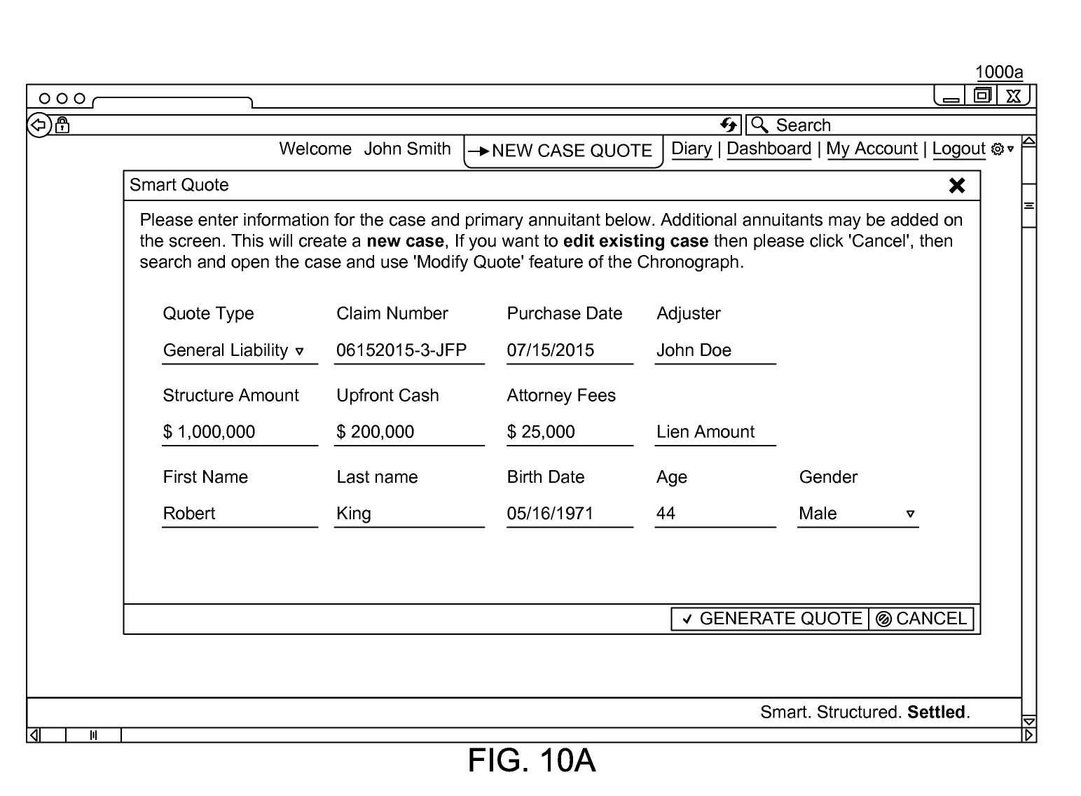

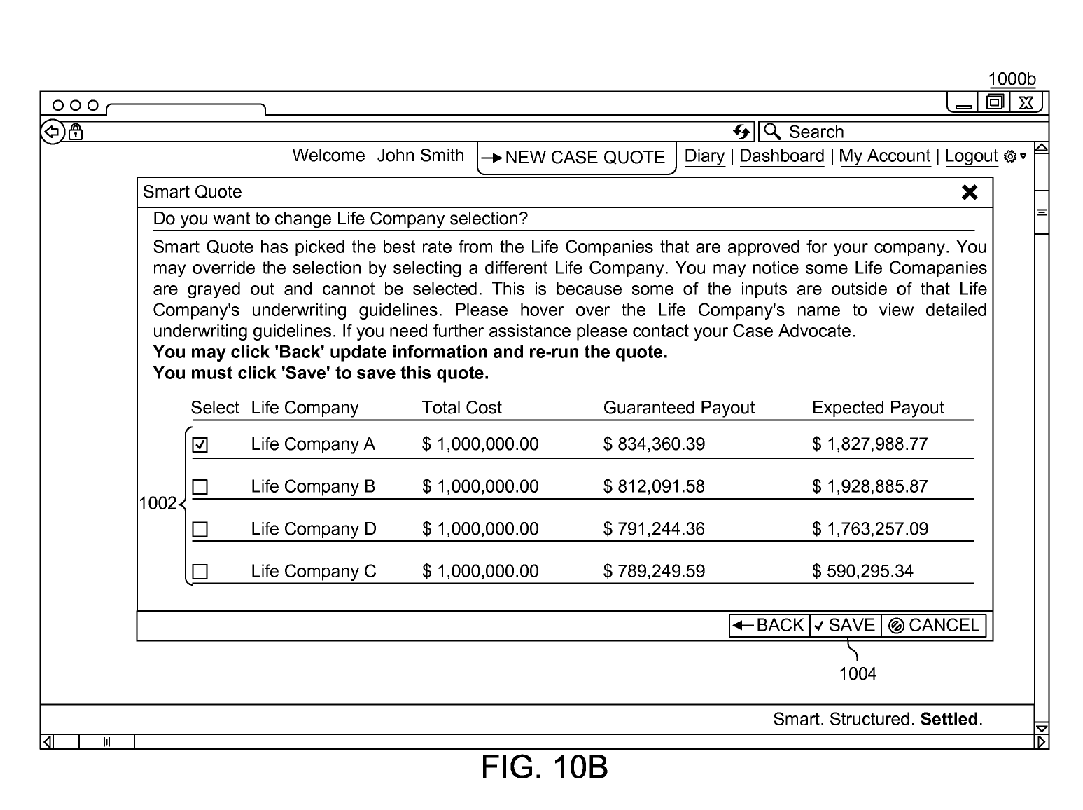

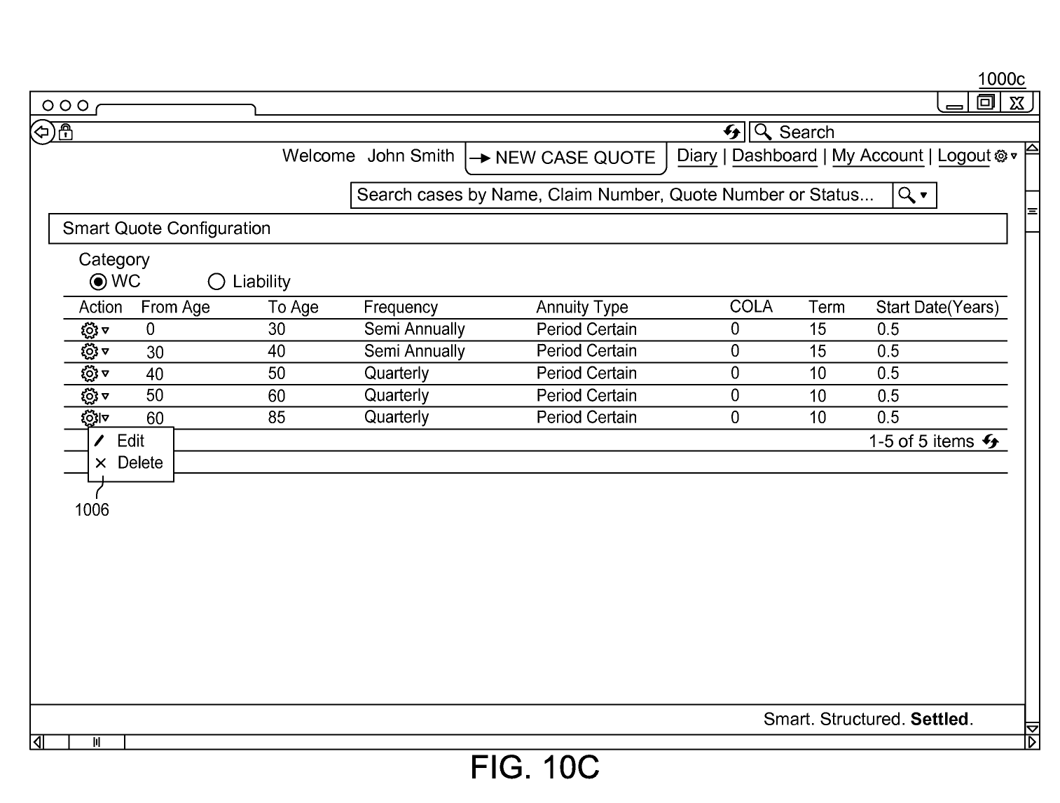

FIG. 10A illustrates an interface 1000a for generating a quote (e.g., SmartQuote, quick quote) according to an exemplary embodiment. In certain embodiments, interface 1000a is the first interface used to initiate a quoting process. The quote interface may use (e.g., retrieve) data stored in a configuration table (e.g., FIG. 10C) to identify and apply key components of a quote and design a “best fit” for the quote. Moreover, the quoting process collects basic information about the quote and shops the quote among eligible life companies providers (e.g., life insurance providers).

More specifically, the interface 1000a includes prompts to obtain information for generating a quote to be shopped to life companies. The information to be input includes a quote type (e.g., general liability), claim number, purchase date, adjuster, structure amount, upfront cash, attorney fees, lien amount, and first name, last name, birth date, age and gender of the annuitant. The interface 1000a may include a “Generate Quote” button which, if selected (e.g., clicked) causes the quote to be shopped to providers.

In certain embodiments, in the quoting process, the structured settlement management company and/or system 101 may use (e.g., apply) stored and/or predetermined rules (e.g., underwriting rules) and rates for each life company. The rules may be stored in a storage system or device of or associated with the structured settlement management system 101. Rates and rating algorithms are enabled by integration of the life companies' rate generating systems and software with the structured settlement management system, in order to ensure accuracy and minimize maintenance and redundancy. Rates and rating algorithms are continuously monitored and updated by the structured settlement system in order to obtain optimal results. Eligible life companies are determined by the rules of the client or customer company (e.g., corresponding to companies' systems 107), which are stored and managed by the structured settlement management system, for example, in a configuration file, as shown in FIG. 6C.

Quotes are obtained and presented in real time (e.g., approximately concurrently, within 1 second, 2 seconds, 5 seconds, 10 seconds, 30 seconds (e.g., with the submission of the quote request)) and returned to create and provide a structured settlement (e.g., Chronograph) and other interfaces, to enable comparison of obtained quotes. In certain embodiments, the quoting process selects the “best rate” based on the greatest financial advantage, in aggregate, to the annuitant (e.g., claimant, beneficiary, or the like). In certain embodiments, life companies are selected according to (1) the ability of the life company to match annuitant requirements to underwriting rules or requirements, and/or (2) the eligibility of the life companies with the client company.

A “best rate” (e.g., best fit) may be overridden by an adjuster or claims professional, as shown in FIG. 10B. FIG. 10B illustrates an interface 1000b to modify life company selections in a quoting process according to an exemplary embodiment. More specifically, the interface 1000b lists one or more approved life companies 1002, including the total cost, guaranteed payout and expected payout quoted by each life company. In certain embodiments, the “best fit” or default life company is selected (e.g., with a checkbox). The “best fit” may be changed by checking a checkbox associated with a different one of the life companies listed on the interface 1000b and, in turn, selecting a “Save” button or command 1004.

The quoting (e.g., SmartQuote) enabled by the interfaces illustrated in FIGS. 10A and 10B provide real time shopping for quotes based on internal rules-based algorithms that are based on client or customer company preferences, life company underwriting rules, and precise application of rating algorithms of involved life companies. Moreover, adjusters (e.g., participants) are able to generate (e.g., obtain) and compare quotes in real time. “Best fit” quotes generally provide the most useful and chosen quotes to clients, in over 80% of quote request. The best fit quotes use configurations (e.g., FIG. 10C) to regress incoming data with internal tables to create the best fits for the specified requirements and/or characteristics of the quote.

Quotes (e.g., SmartQuotes) may be modified and multiple iterations of quotes may be prepared and stored for subsequent action (e.g., deciding whether to proceed at a later time). By virtue of these features of the quoting interfaces and process, adjusters are able to manage and control the quoting process.

FIG. 10C illustrates an interface 1000c for setting and/or configuring base quotes according to an exemplary embodiment. Base quotes refers to predetermined parameters of an “ideal” quote. Base quotes are initially set to default values. In certain embodiments, the base quotes are adjusted and/or modified by clients and/or participants (e.g., adjusters) in accordance with their standards, via the action buttons 1006, which allow a base quote to be modified and/or deleted.

Each base quote is associated with values including an age range (e.g., from age, to age), frequency (e.g., monthly, annually), an annuity type (e.g., period certain, lump sum, life with period certain), an associated cost of living adjustment (COLA), a settlement amount range (e.g., from settlement, to settlement), a term (e.g., in years), and a start date (e.g., in years) calculated from the date of the quote.

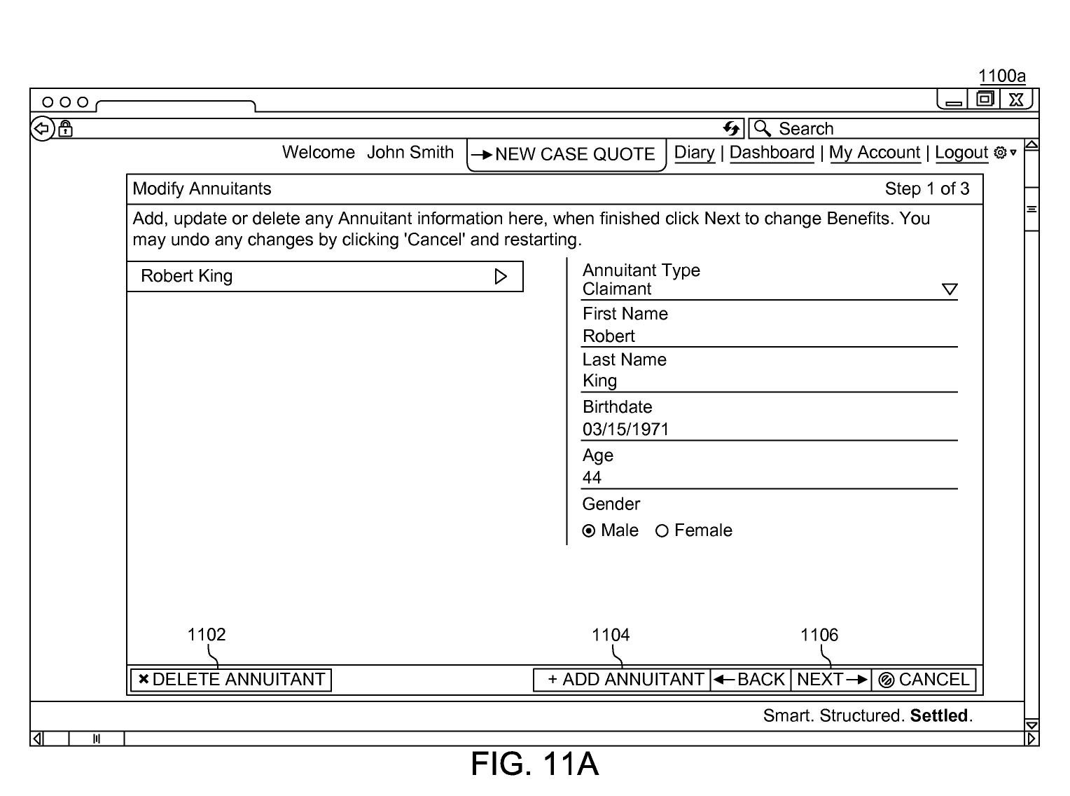

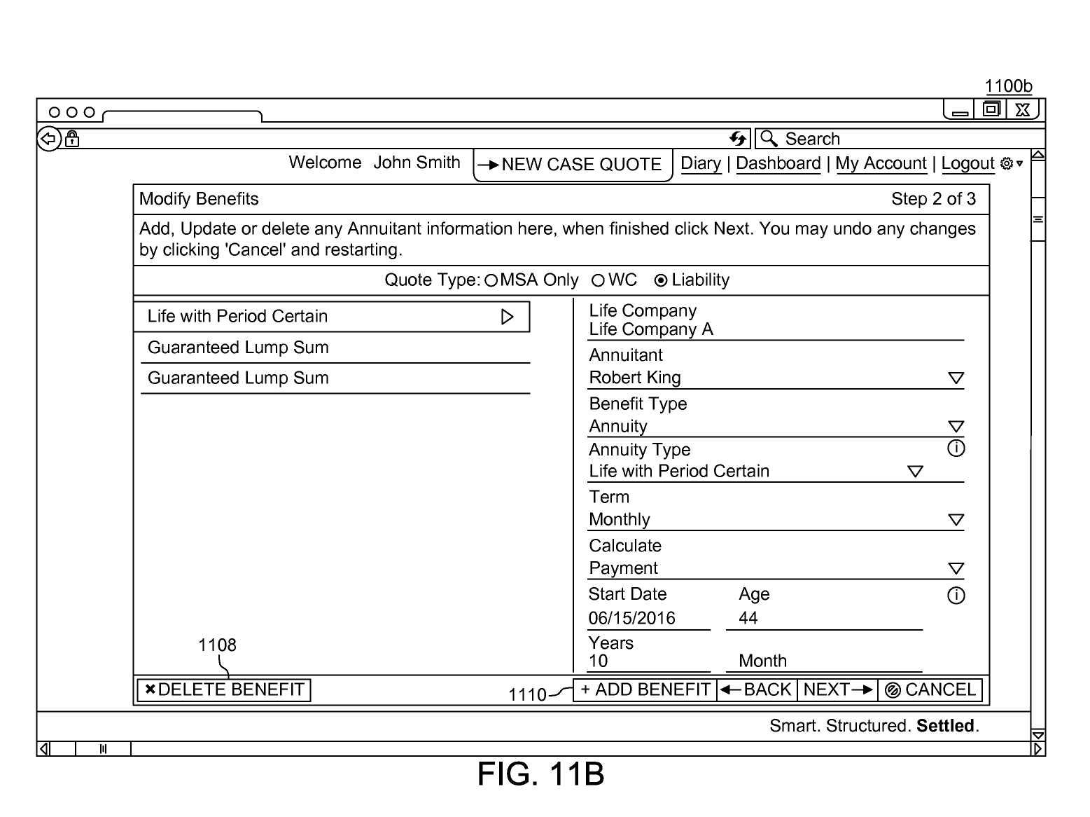

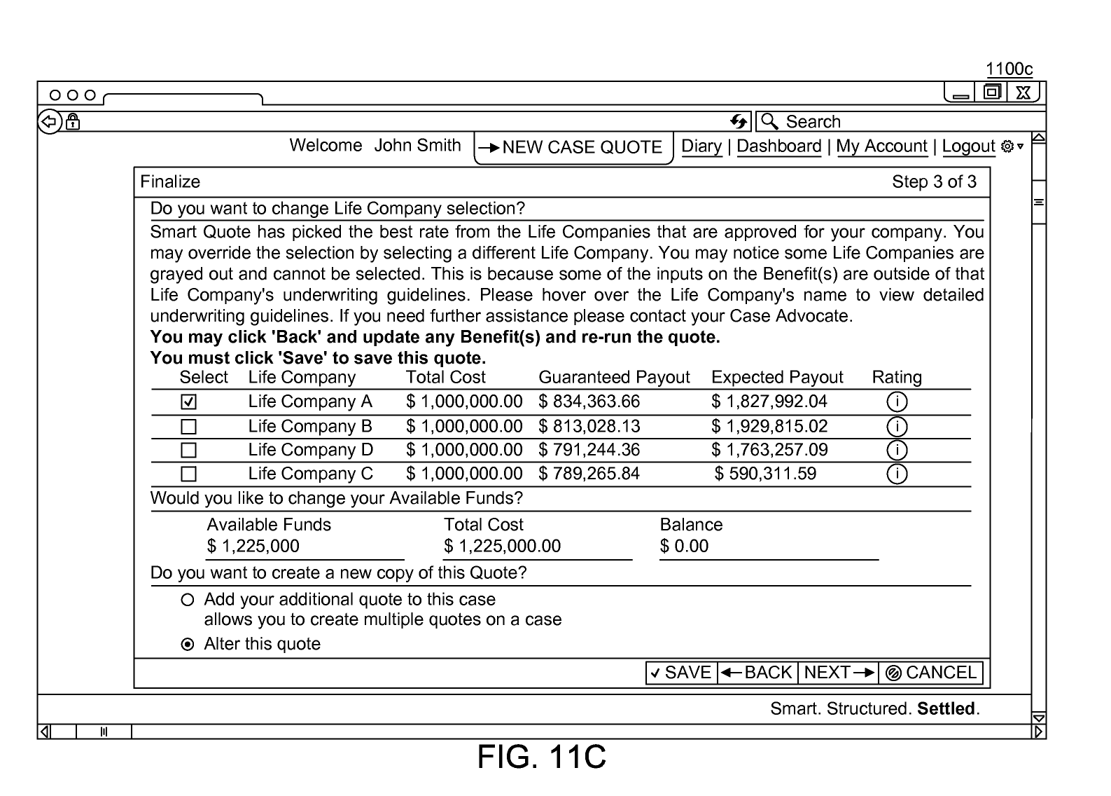

FIGS. 11A-11C illustrate interfaces for modifying quotes according to exemplary embodiments. In certain embodiments, FIGS. 11A-11C illustrate interfaces that are part of a quote modification wizard widget that allows previously-generated quotes (e.g., SmartQuotes) to be modified by, among other things: adding, changing, and deleting annuitants; adding, changing, and deleting benefits; changing available funds, selecting life insurance companies; and creating copies of quotes.

By virtue of the interfaces and processes illustrated in FIGS. 11A-11C adjusters are able to use base quotes to generate ideal investments. That is, base quotes serve as a starting point and/or guideline for obtaining the most beneficial investments for the company and/or annuitant (e.g. claimant). Moreover, it is possible to continue to modify quotes and compare different scenarios to identify the best possible outcomes. Modified quotes are again edited against all underwriting rules for each company. Areas of conflict (e.g., based on the rules) may be highlighted in the interfaces 1100a, 1100b and 1100c, so that adjusters and/or claims professionals can visualize, in real time, any potential issues and surrounding facts regarding quotes. In certain embodiments, a balancing tool may be used to adjust the amount of available funds.

More specifically, FIG. 11A illustrates an interface 1100a for modifying annuitant information according to an exemplary embodiment. In certain embodiments, the annuitant data is used to generate and/or provide a quote (e.g., SmartQuote). When an annuitant name is selected, prompts are presented to view and/or modify annuitant data including the annuitant type, (e.g., claimant), first name, last name, birth date, age, and gender. An annuitant may be deleted by selecting (e.g., clicking, tapping) the delete annuitants button 1102. On the other hand, an annuitant may be added by selecting the add annuitant button 1104. Adding an annuitant causes a quote to be modified and/or generated for one or more annuitants including the newly-added annuitant. Once annuitant information has been viewed and/or modified, benefits associated with a quote may be modified by selecting the next button 1106, which causes a benefits modification interface to be displayed and/or rendered as shown in FIG. 1 lB.

FIG. 11B illustrates an interface 1100b for modifying benefits information associated with a quote, according to an exemplary embodiment. For example, the quote type may be changed from MSA Only, to WC or Liability by selecting a corresponding radial button. Selection of one of the quote types causes available benefits to be displayed. In one example implementation, selecting the liability quote type causes available (e.g., stored, preconfigured) benefit types to be listed, including life with period certain, guaranteed lump sum, and another guaranteed lump sum benefit. Selecting one of the benefits causes associated information to be shown, including life company, annuitant, benefit type, annuity type, term, parameters used for the calculations of the quote (e.g., payment, start date, age, years, COLA). Benefits may be deleted and or added by selecting corresponding buttons 1108 and 1110, respectively. Selecting a next button causes a widget and/or interface for finalizing quote modifications to be displayed and/or rendered as shown in FIG. 11C.

FIG. 11C illustrates an interface 1100c for finalizing quote modifications accordion to an exemplary embodiment. Final quote modifications which may be adjusted via the interface 1100c include selecting the desired life company and changing the amount of available funds. Moreover, the interface 1100c allows the updated and/or modified quote parameters (e.g., FIGS. 11A-11C) to be used to modify the existing quote or to create a new quote using those updated and/or modified parameters.

FIG. 12A illustrates a chronograph interface 1200a (e.g., ChronoGraph) for managing quotes according to an exemplary embodiment. The chronograph interface 1200a provides outputs and/or displays, results of a quote (e.g., SmartQuote), and tools to, among other things, modify the quote, create new versions and expansion of the quote, perform what-if scenarios, graphically represent or visualize the impact of a quote based on industry metrics, and forward benefit payment projections. The chronograph interface 1200a may be used by a structured settlement system user, including claims adjusters, claims professionals, case advocates, and the like.

As shown in FIG. 12a, the chronograph interface 1200a displays, outputs and/or provides quote information. The quote information may be received and/or stored through a quoting (e.g., SmartQuote) process, in which quote data and/or parameters are obtained. The quote information displayed in interface 1200a includes, for instance, the annuitant (e.g., John Keely), a status of a quote (e.g., Quoted), the date of the quote (e.g., Jul. 8, 2015), the expiration date of the quote (e.g., Jul. 15, 2015, the purchase date of the quote (e.g., Aug. 7, 2015) and the claim number.

Using the “Select Quote” drop down menu 1202, a user can choose other quotes to visualize in the chronograph interface 1200a. In turn, the amount of available funds (e.g., $35,000) associated with the quote is retrieved and/or displayed. “What-if” analyses may in turn be performed using one or more of the sliding bars (or the like) 1204. That is, the sliding bars (e.g., sliders) may be used to adjust different amounts of benefits and/or quote components. In certain embodiments the sliders 1204 are initialized or preset to the amounts determined during a quoting process.

Benefits and/or quote components include, for example, life with period certain benefit, guaranteed lump sums, attorney fees, liens, cash, and the like. Each of these benefits and/or quote components may be increased or decreased. If there is a surplus of available funds which remains to be used to adjust one of the sliders 1204, it is reflected in a “Balance” total. That is, the balance amount is automatically updated as benefits and/or quote components are adjusted, thereby providing a real-time indication of (1) how much of the available funds is still available for funding, and (2) how the available funds are distributed.

Once the sliders have been adjusted to an amount that meets or exceeds the amount of available funds, a warning or the like 1205 (e.g., “You have reached or exceeded your Available funds limit”) may be displayed, informing the user of the structured settlement system that the sliders of one benefit or quote component cannot be increased without decreasing another. In some example implementations, the amounts of each benefit and/or quote component can be modified via direct entry, rather than using sliders 1204.

As the sliders are adjusted (e.g., increased or decreased), the quote (or re-quote) is calculated in real time (e.g., 1 second, 2 seconds, 5 seconds, 10 seconds), and corresponding totals and graphics are updated accordingly. For example, modifying the benefits and/or quote components causes graphs such as graph 1206 and 1208 to be automatically and interactively updated and displayed in real-time on the interface 1200a. Graph 1206 illustrates a structure versus market graph showing the impact of selecting the quote (as adjusted using the sliders 1204) versus investing the available funds in more traditional investments such as equity markets, using predetermined algorithms. Graph 1208 is a structured benefit schedule showing the defined flow of future payments both in guaranteed and in expected terms, using predetermined algorithms that determine life expectancy norms and/or rules relative to case details.

In some example embodiments, graph 1206 illustrated in FIG. 12A shows an inherent stability and consistency of a solution and/or structured settlement provided by a structured settlement management system versus traditional market investment options. The graph 1206 uses an annuitant's actual quote and makes certain assumptions for illustrative purposes, as described in further detail below.

The Chronograph interface 1200a may also be used to save a quote, as modified and/or updated (e.g., using sliders 1204), by selecting (e.g., clicking, tapping) the “Save” button 1210. A quote (e.g., benefits, life companies, annuitants) may also be modified (e.g., via the modification wizard of FIGS. 11A-11C) by selecting the “Modify Quote” button 1212. If a quote is modified via the modification wizard, the Chronograph interface 1200a may be refreshed (e.g., updated) by selecting the “Refresh Quote” button 1214, which causes quote information, including updated data, to be retrieved and used to populate the Chronograph interface 1200a. The Chronograph interface 1200a (e.g., the quote information and visualizations thereon) may be output (e.g., printed) in a single report by selecting the “Print Proposal” button 1216.

FIGS. 12B and 12C illustrate a Chronograph settlement proposal 1200b and 1200c according to an exemplary embodiment. The settlement proposal, comprising parts 1200b and 1200c, include information reflected in the Chronograph interface 1200a and which was selected to be printed by clicking the button 1216 in the interface 1200a. That is, the Chronograph settlement proposal 1200b and 1200c may include graphs (e.g., structure vs. market, structure benefit schedule), benefits and/or quote components. In certain embodiments, the quote proposal may be printed (e.g., as a PDF) and/or electronically delivered by an adjuster and/or adjuster system (or claims professional).

In certain embodiments, a chronograph interface is used for managing structured settlements. The chronograph interface may be an interface, graphical rendering, representation, and/or graphical user interface generated, presented and/or caused to be displayed by the structured settlement provider system. The chronograph interface includes claim information, quote information, settlement amount, quote parameters, and long-term income and benefits information.

The claim information may include information regarding a selected claim. The selected claim refers a claim corresponding to a case that was either searched for (e.g., via a search box) or selected from a list of cases. Moreover, the selected claim refers to the claim for which quote information, settlement amount and quote parameters are displayed in the chronograph interface. The claim information may include a claim number; first name, last name, date of birth, age, gender, and tax bracket of the claimant associated with the claim; and/or the jurisdiction state (e.g., the state in which the case is being heard and/or processed). The claim information may also include information (e.g., a highlight, check mark) indicating the status of the claim (e.g., open, pending, settled). It should be understood that the claim information may include any information associated with a case, claim and/or claimant.

The tabs include chronograph tab, shop rates tab, history tab, calculators tab, documents tab, and case data tab. The chronograph interface includes a selected chronograph tab, which, when selected, causes the chronograph interface to display quote information, settlement amount, quote parameters and/or long-term income and benefits information.

The quote information includes information regarding selected and/or best quotes. In certain embodiments, the quote information includes quotes sufficient to satisfy a total settlement amount (e.g., settlement amount). The quote information may include, for each quote, a benefit type, annuity type, amount, term, start date, years, months, cost of living adjustment percentage (COLA %), premium, insurance company and/or assignment. The benefit type may be the type of financial benefit (e.g., annuity, lump sum, attorney fees, cash) associated with a quote. The annuity type indicates whether the annuity is a life annuity, a lump sum, a periodic annuity, or the like. The amount indicates the total amount (e.g., payment) to be paid out by the annuity over its life (e.g., the life of the annuity). The term indicates when and/or how frequently payments (e.g., amount) are to be made to the claimant and/or beneficiary. The start date indicates a date on which payments to the claimant and/or beneficiary are to begin. The years and months indicate the length of time (measured in years and/or months) during which payments are to be made to the claimant and/or beneficiary. In other words, the years and months indicate the life of the annuity. The COLA % indicates the cost of living adjustment factored into the annuity. The premium indicates the quoted cost to obtain (e.g., buy) the annuity. The insurance company indicates the seller of the annuity. The assignment indicates whether it is qualified or not qualified in accordance with predetermined criteria (e.g., set by the Internal Revenue Code).

The settlement amount indicates the total amount of the settlement. The quote parameters indicate the distribution of amounts by benefit type. That is, the quote parameters indicate how a settlement amount (e.g., settlement amount) is to be distributed. In certain embodiments, the sum of the quote parameters are equal to the total settlement amount. In certain embodiments, quote parameters may be adjusted using sliding markers, inputting values (e.g., totals, percentages), and the like.

The long-term income and benefits information includes graphs, charts, data, and the like indicating income and benefits gained by the defendant by the purchase of the annuities listed in the quote information. The long-term income and benefits information may include total wealth accumulation, capital accumulation and tax savings.

FIG. 13 illustrates an interface 1300 for quote shopping according to an exemplary embodiment. The interface 1300 provides, displays, and/or outputs, in a single source, the quotes that are available for selection. That is, the interface 1300 acts as a shopping interface, where available quotes can be viewed and analyzed to determine which quote to select. Moreover, the interface 1300 acts as a market basket providing accurate “live” quotes to a participant user (e.g., adjuster or adjuster system) immediately after a real-time quote rating process is performed. The quotes in the shopping interface 1300 are selected using the rating algorithms of the life companies (e.g., stored by the structured settlement provider system). Available life companies are identified using configuration files, described above, that indicate eligible companies, underwriting rules, and the like for each life company, and are run (e.g., compared, applied) against the characteristics and/or data of each quote. In certain embodiments, rating results are displayed for each quote iteration saved with a case. In certain embodiments, a quote that is recommended by the structured settlement management company and/or system may be highlighted (e.g., $69,309 payout from Life Co. A). In certain embodiments, recommended quotes may be selected by considering one or more of (1) the highest payout (e.g., if liability or workers compensation), (2) the lowest cost (e.g., if MSA), and/or (3) the predetermined default life company for a client.

The interface 1300 may be adjusted to provide shopping means by (1) payout (e.g., via link 1302), or (2) cost (e.g., via link 1304). The interface for shopping by payout, which is shown in FIG. 13, provides information regarding total payouts (e.g., $69,309; $64,543) calculated for each life company (e.g., Life Co. A, Life Co. B). Payouts are determined by the quotes calculated by the life companies' rating algorithms that are used in the quote generation described above (e.g., SmartQuote). In one example embodiment, the interface 1300 may be adjusted to shop by price, so that the cost for each life company quote is displayed.

FIG. 14 illustrates a quote comparison interface 1400 according to an exemplary embodiment. The quote compassion interface 1400 provides users (e.g., adjusters, case advocates) the ability to view and compare costs, payouts and other data for each quote that was generated and/or saved. That is, the interface 1400 outputs and/or displays quote information for visually comparing (e.g., by an adjuster via an adjuster's system) results in real time as the quotes are generated and/or received. In certain embodiments, the quotes being compared are not editable via the interface 1400.

FIGS. 15A-15C illustrate checklists 1500a, 1500b, and 1500c, respectively, that are used, for example, by case advocates, to gather data and/or information from, for example, adjusters. In certain embodiments, checklists may be generated and/or displayed to the case advocate systems for use by the case advocates based on the type of business that the adjusters and adjuster systems are associated with. In certain embodiments, the checklists 1500a, 1500b, and 1500c provide cascading rules-based data fields. That is, when one question is answered (e.g., via corresponding inputs), the structured settlement group determines the appropriate follow-up question(s) to display in the checklist based on the received answer. This, in turn, provides safeguards to the structured settlement system and users to ensure that the necessary and/or required information is collected and/or stored, for example, to calculate and provide the most valuable quotes. Response data is stored in a database managed by and/or associated with the structured settlement system and used for analytics, case inquiries, and setting diaries for future action and follow up on a timely basis. In certain embodiments, the checklists 1500a, 1500b and 1500c provide guidance and contextual awareness of the field and function to the case advocates via the case advocate systems. Questions included in the checklists are developed by structured settlement experts based on structured settlement history data.

FIG. 15A illustrates a medical savings account (MSA) checklist interface 1500a according to an exemplary embodiment. The MSA checklist interface 1500a illustrates a checklist specifically generated for medical savings accounts, and provides questions to collect information. Each question is generated and/or modified based on received answers. Examples of questions presented in the MSA checklist interface include, but are not limited to, the following:
Do you need help resolving the underlying claim along with a structure for the MSA only?
Do you have an MSA report already?
Are there underlying medical conditions that make you think we should seek a rated age?
Have you accounted for and negotiated any condition payments/liens on this case?

FIG. 15B illustrates a workers compensation (WC) checklist interface 1500b according to an exemplary embodiment. The WC checklist interface 1500b illustrates a checklist specifically generated for workers compensation, and provides questions to collect information. Each question is generated and/or modified based on received answers. Examples of questions presented in the WC checklist interface include:
What can I help you do today? Are you attempting to settle this case right now?
Are there additional defendants to consider like an excess carrier, third party liability carrier, apportionment with another employer? I ask because it could lower the cost of the MSA and over settlement?
Are there underlying medical conditions that make you think we should seek a rated age?
Is there a mediation, settlement conference, or trial scheduled in this case?
Have you received authority or determined case value?
Are you in a potion to make an offer?

FIG. 15C illustrates a liability checklist interface 1500c according to an exemplary embodiment. The liability checklist interface 1500c illustrates a checklist specifically generated for liability claims, and provides questions to collect information. Each question is generated and/or modified based on received answers. Examples of questions presented in the liability checklist interface include, but are not limited to, the following:
How do you want to be contacted on this case? Do you prefer phone calls, or e-mails? How often would you like me to follow up with you?
What is your timeline and plan for the resolution of this case?
Do you have any summary docs that would give me an overview of the cse type and issues involved? Like a Case Summary, Litigation Report, or a copy of the Complaint?

FIG. 16A illustrates an interface 1600a for managing documents associated with a settlement according to an exemplary embodiment. Interface 1600a is an interface associated with a case. A documents widget 1602 can be used to view stored documents associated with a case (e.g., “Legal Docs—Graph”) or to search among a list of documents using a search box or the like, 1604. When a document is selected and/or highlighted in the documents widget 1602, a details widget 1606 displays information regarding that document. For example, as shown in FIG. 16A, the details widget displays the document type, name, extension and creation date associated with the “Legal Docs—Graph” document selected in documents widget 1602. The details widget 1606 also includes buttons, links or the like to upload (1608), download (1610) or edit (1612) documents and/or document details. Selecting the “Upload” button 1608 causes an interface to be rendered and/or displayed for adding a document, as shown in FIG. 16B.

FIG. 16B illustrates an interface 1600b for adding documents to a case according to an exemplary embodiment. In some example embodiments, documents may be added to the structured settlement management system by dragging and dropping files into the interface 1600b, or by browsing a system to select documents to add (e.g., Form 1, Document 2, Settlement Doc). That is, multiple documents may be added via a single document upload interface. As described in further detail with reference to FIG. 16A, if an upload button is selected, the interface 1600b is displayed, via which a document name, location and type (e.g., correspondence, legal document, lock in, medical document, proposal, rated age, SAR, settlement document) can be selected and/or input. A progress bar may be displayed, indicating the progress of the upload of the one or more documents. In turn, selecting the save button causes the uploaded one or more documents to be saved to the structured settlement system and displayed in the list of documents (e.g., document widget 1602 in FIG. 16A) for the respective case.

FIG. 16C illustrates an interface 1600c for viewing diaries according to an exemplary embodiment. Diaries are described above in more detail with reference to FIG. 9A. Interface 1600c shows a diary interface that is accessed by a user (e.g., Bruce Lee) via a chronograph interface. The interface 1600c lists and/or displays cases and/or quotes with which the user is associated. In some example implementations, the user may be a claims professional, adjuster, or the like.

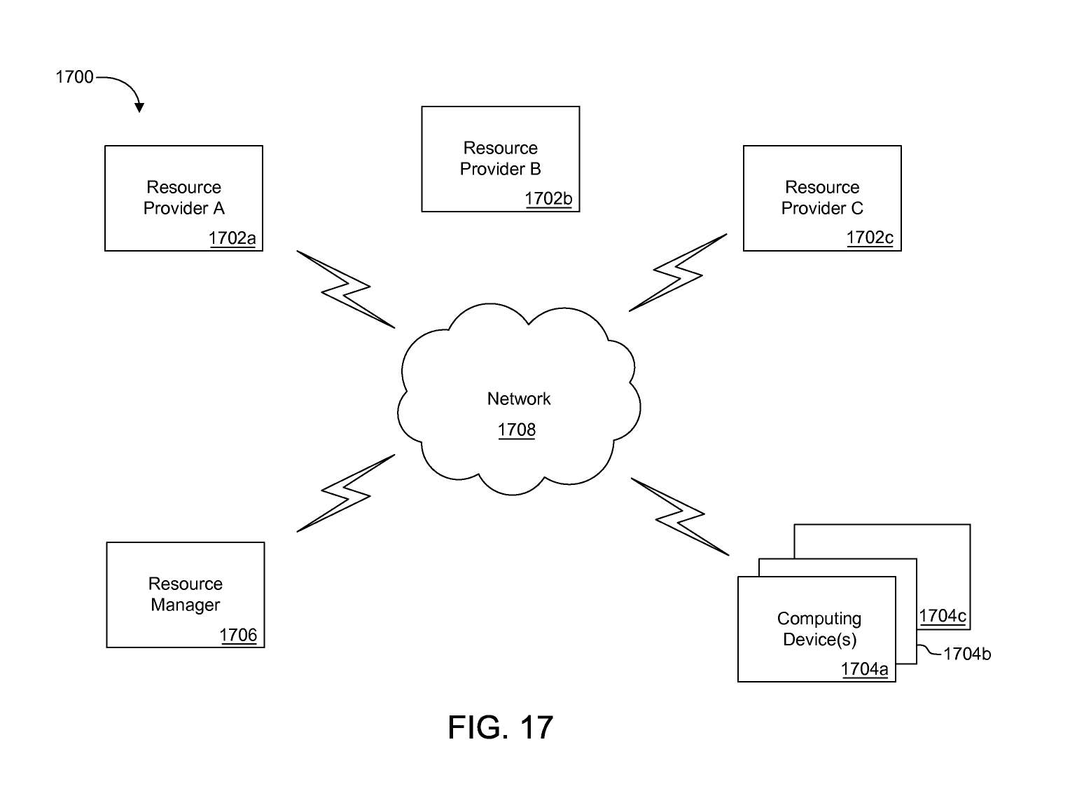

FIG. 17 shows an illustrative network environment 1700 for use in the methods and systems for managing structured settlements, as described herein. In brief overview, referring now to FIG. 17, a block diagram of an exemplary cloud computing environment 1700 is shown and described. The cloud computing environment 1700 may include one or more resource providers 1702a, 1702b, 1702c (collectively, 1702). Each resource provider 1702 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1702 may be connected to any other resource provider 1702 in the cloud computing environment 1700. In some implementations, the resource providers 1702 may be connected over a computer network 1708. Each resource provider 1702 may be connected to one or more computing device 1704a, 1704b, 1704c (collectively, 1704), over the computer network 1708.

The cloud computing environment 1700 may include a resource manager 1706. The resource manager 1706 may be connected to the resource providers 1702 and the computing devices 1704 over the computer network 1708. In some implementations, the resource manager 1706 may facilitate the provision of computing resources by one or more resource providers 1702 to one or more computing devices 1704. The resource manager 1706 may receive a request for a computing resource from a particular computing device 1704. The resource manager 1706 may identify one or more resource providers 1702 capable of providing the computing resource requested by the computing device 1704. The resource manager 1706 may select a resource provider 1702 to provide the computing resource. The resource manager 1706 may facilitate a connection between the resource provider 1702 and a particular computing device 1704. In some implementations, the resource manager 1706 may establish a connection between a particular resource provider 1702 and a particular computing device 1704. In some implementations, the resource manager 1706 may redirect a particular computing device 1704 to a particular resource provider 1702 with the requested computing resource.

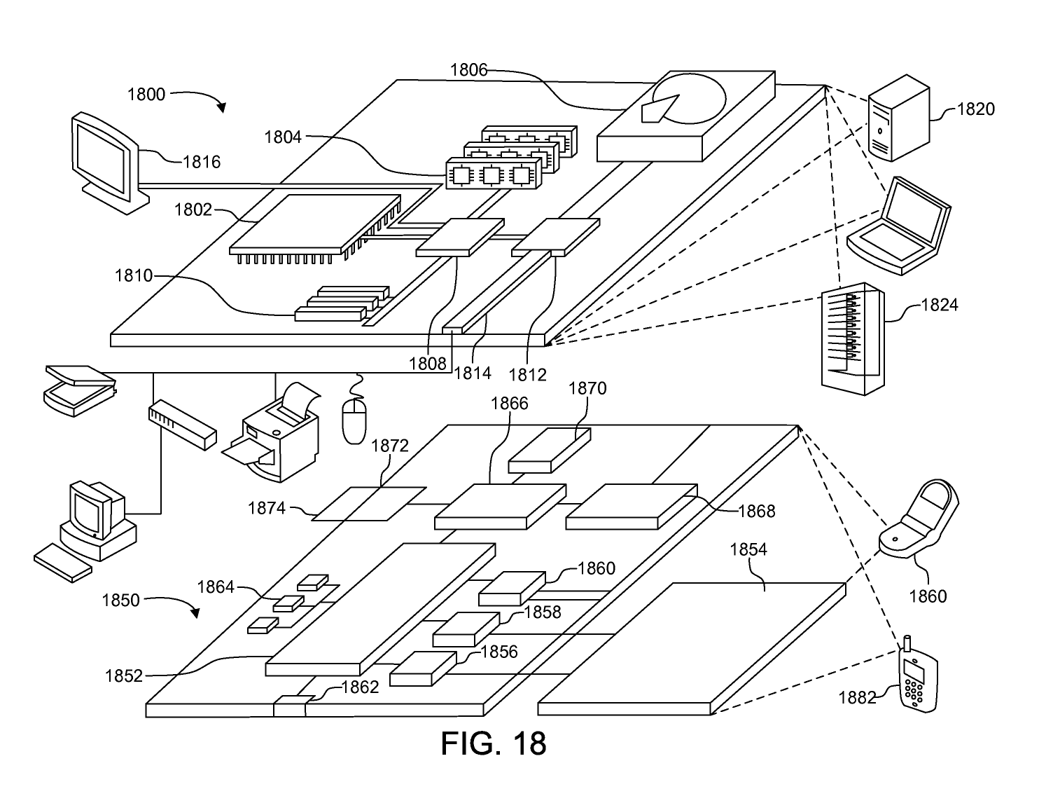

FIG. 18 shows an example of a computing device 1800 and a mobile computing device 1850 that can be used in the methods and systems described in this disclosure. The computing device 1800 is intended to represent various forms of digital computers, such as laptops, desktops, workstations, personal digital assistants, servers, blade servers, mainframes, and other appropriate computers. The mobile computing device 1850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and may be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1804 stores information within the computing device 1800. In some implementations, the memory 1804 is a volatile memory unit or units. In some implementations, the memory 1804 is a non-volatile memory unit or units. The memory 1804 may also be another form of computer-readable medium, such as a magnetic or optical disk.

The storage device 1806 is capable of providing mass storage for the computing device 1800. In some implementations, the storage device 1806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1802), perform one or more methods, such as those described above. The instructions can also be stored by one or more storage devices such as computer- or machine-readable mediums (for example, the memory 1804, the storage device 1806, or memory on the processor 1802).

The high-speed interface 1808 manages bandwidth-intensive operations for the computing device 1800, while the low-speed interface 1812 manages lower bandwidth-intensive operations. Such allocation of functions is an example only. In some implementations, the high-speed interface 1808 is coupled to the memory 1804, the display 1816 (e.g., through a graphics processor or accelerator), and to the high-speed expansion ports 1810, which may accept various expansion cards (not shown). In the implementation, the low-speed interface 1812 is coupled to the storage device 1806 and the low-speed expansion port 1814. The low-speed expansion port 1814, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1800 may be implemented in a number of different forms, as shown in the figure. For example, it may be implemented as a standard server 1820, or multiple times in a group of such servers. In addition, it may be implemented in a personal computer such as a laptop computer 1822. It may also be implemented as part of a rack server system 1824. Alternatively, components from the computing device 1800 may be combined with other components in a mobile device (not shown), such as a mobile computing device 1850. Each of such devices may contain one or more of the computing device 1800 and the mobile computing device 1850, and an entire system may be made up of multiple computing devices communicating with each other.

The mobile computing device 1850 includes a processor 1852, a memory 1864, an input/output device such as a display 1854, a communication interface 1866, and a transceiver 1868, among other components. The mobile computing device 1850 may also be provided with a storage device, such as a micro-drive or other device, to provide additional storage. Each of the processor 1852, the memory 1864, the display 1854, the communication interface 1866, and the transceiver 1868, are interconnected using various buses, and several of the components may be mounted on a common motherboard or in other manners as appropriate.

The processor 1852 can execute instructions within the mobile computing device 1850, including instructions stored in the memory 1864. The processor 1852 may be implemented as a chipset of chips that include separate and multiple analog and digital processors. The processor 1852 may provide, for example, for coordination of the other components of the mobile computing device 1850, such as control of user interfaces, applications run by the mobile computing device 1850, and wireless communication by the mobile computing device 1850.

The processor 1852 may communicate with a user through a control interface 1858 and a display interface 1856 coupled to the display 1854. The display 1854 may be, for example, a TFT (Thin-Film-Transistor Liquid Crystal Display) display or an OLED (Organic Light Emitting Diode) display, or other appropriate display technology. The display interface 1856 may comprise appropriate circuitry for driving the display 1854 to present graphical and other information to a user. The control interface 1858 may receive commands from a user and convert them for submission to the processor 1852. In addition, an external interface 1862 may provide communication with the processor 1852, so as to enable near area communication of the mobile computing device 1850 with other devices. The external interface 1862 may provide, for example, for wired communication in some implementations, or for wireless communication in other implementations, and multiple interfaces may also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 may also be provided and connected to the mobile computing device 1850 through an expansion interface 1872, which may include, for example, a SIMM (Single In Line Memory Module) card interface. The expansion memory 1874 may provide extra storage space for the mobile computing device 1850, or may also store applications or other information for the mobile computing device 1850. Specifically, the expansion memory 1874 may include instructions to carry out or supplement the processes described above, and may include secure information also. Thus, for example, the expansion memory 1874 may be provided as a security module for the mobile computing device 1850, and may be programmed with instructions that permit secure use of the mobile computing device 1850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1852), perform one or more methods, such as those described above. The instructions can also be stored by one or more storage devices, such as one or more computer- or machine-readable mediums (for example, the memory 1864, the expansion memory 1874, or memory on the processor 1852). In some implementations, the instructions can be received in a propagated signal, for example, over the transceiver 1868 or the external interface 1862.

The mobile computing device 1850 may communicate wirelessly through the communication interface 1866, which may include digital signal processing circuitry where necessary. The communication interface 1866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1868 using a radio-frequency. In addition, short-range communication may occur, such as using a Bluetooth®, Wi-Fi™, or other such transceiver (not shown). In addition, a GPS (Global Positioning System) receiver module 1870 may provide additional navigation- and location-related wireless data to the mobile computing device 1850, which may be used as appropriate by applications running on the mobile computing device 1850.

The mobile computing device 1850 may also communicate audibly using an audio codec 1860, which may receive spoken information from a user and convert it to usable digital information. The audio codec 1860 may likewise generate audible sound for a user, such as through a speaker, e.g., in a handset of the mobile computing device 1850. Such sound may include sound from voice telephone calls, may include recorded sound (e.g., voice messages, music files, etc.) and may also include sound generated by applications operating on the mobile computing device 1850.

The mobile computing device 1850 may be implemented in a number of different forms, as shown in the figure. For example, it may be implemented as a cellular telephone 1880. It may also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing structured settlements associated with cases, the method comprising:
receiving, by a processor of a structured settlement system, a first input from a first user, the first input comprising instructions to access a graphical user interface provided by a structured settlement system;
causing to display, by the processor of the structured settlement system, the graphical user interface in response to the instructions in the first input, the graphical user interface comprising at least one of:
(i) a diary interface comprising case data corresponding to one or more of the cases associated with the first user;
(ii) a settlement dashboard interface comprising settlement metrics associated with one or more of the cases associated with the first user;
(iii) a quoting interface comprising prompts for receiving quote data for a new case, wherein one or more quotes are calculated based at least in part on the received quote data;
(iv) a quote modification interface comprising prompts for receiving quote data, wherein one of the quotes is calculated based at least in part on the received quote data; and
(v) a chronograph interface comprising quote data of a quote associated with one of the cases;
receiving, by the processor of the structured settlement system, one or more interface inputs from the first user, the one or more interface inputs being received via the graphical user interface; and
processing, by the processor of the structured settlement system, the one or more interface inputs in real-time.

2. The method of claim 1, wherein the graphical user interface is caused to be displayed, by the processor of the structured settlement system, at a display of a computing device associated with the first user.

3. The method of claim 1,
wherein the quote data received by the processor of the structured settlement system via the quoting interface is selected from the group comprising a quote type, claim number, purchase date, adjuster, structure amount, upfront cash, attorney fees, lien amount, annuitant name, annuitant birth date, annuitant age, and annuitant gender,
wherein the quote data is received from one or more of a memory communicatively coupled to the structured settlement system or over a network from a computing device associated with the first user, and
wherein the method further comprises obtaining in real time, by the processor, one or more quotes associated with life companies, the one or more quotes being obtained based in part on the quote data, one or more rules and one or more rates associated with the life companies.

4. The method of claim 3, wherein the structured settlement system is integrated with rate generation software associated with the life companies, the rate generation software comprising rating algorithms used to calculate the one or more rates used to obtain the one or more quotes.

5. The method of claim 4, further comprising identifying, by the processor, a best fit quote from among the one or more quotes, the best fit quote representing the quote with the best financial advantage to the annuitant based in part on configuration tables including predetermined based configurations.

6. The method of claim 5, wherein the first user is an adjuster associated with an adjuster computing device or claims professional associated with a claims professional computing device.

7. The method of claim 1, further comprising:
receiving, by the processor, via the chronograph interface, quote inputs;
calculating, by the processor, updated quote data based on the received quote inputs; and
displaying in real time, by the processor, at least a portion of the updated quote data and graphical representations of the at least a portion of the updated quote data.

8. The method of claim 7, wherein the chronograph interface includes one or more slider widgets, and wherein the quote inputs are received via the slider widgets.

9. The method of claim 7, wherein the graphical representations include graphs or charts illustrating the financial impact of a quote associated with the updated quote data relative to traditional investments.

10. The method of claim 1, wherein the settlement metrics are selected from a group comprising quoted cases, pending cases, locked in cases, awaiting cases, settled cases, expected settlements, completed settlements, percent achieved, and current savings per claim.

11. The method of claim 10, wherein the settlement metrics correspond to cases associated with the first user based on the role of the first user stored a memory communicatively coupled to the structured settlement system.

12. The method of claim 11, wherein the settlement metrics are calculated on a month-to-date, quarter-to-date, or year-to-date basis.

13. The method of claim 1, wherein the settlement dashboard is used to manage the performance of the first user based in part on the settlement metrics.

14. The method of claim 3, wherein the one or more quotes are caused to be displayed in a quote comparison interface.

15. The method of claim 1, further comprising:
receiving, by the processor, via the quoting interface, quote data;
obtaining, by the processor, one or more quotes associated with life companies, based in part on the quote data received via the quoting interface;
identifying, by the processor, a best fit quote from among the one or more quotes;
outputting, by the processor, the one or more quotes, wherein the best fit quote is highlighted in contrast to others of the one or more quotes, wherein the outputting is performed in real time relative to the receiving of the quote data via the quoting interface;
causing to display, by the processor, via the chronograph interface, the quote data of one of the one or more quotes;
receiving, by the processor, via the chronograph interface, quote inputs; and
causing to display, by the processor, via the chronograph interface, updated quote data based in part on the quote inputs.

16. A system for managing structured settlements associated with cases, the system comprising:
at least one memory, and
a processor communicatively coupled to the at least one memory, the processor being operable to:
receive, by the processor, a first input from a first user, the first input comprising instructions to access a graphical user interface provided by a structured settlement system;
cause to display, by the processor, the graphical user interface in response to the instructions in the first input, the graphical user interface comprising at least one of:
(i) a diary interface comprising case data corresponding to one or more of the cases associated with the first user;
(ii) a settlement dashboard interface comprising settlement metrics associated with one or more of the cases associated with the first user;
(iii) a quoting interface comprising prompts for receiving quote data for a new case, wherein one or more quotes are calculated based at least in part on the received quote data;
(iv) a quote modification interface comprising prompts for receiving quote data, wherein one of the quotes is calculated based at least in part on the received quote data; and
(v) a chronograph interface comprising quote data of a quote associated with one of the cases;
receive, by the processor, one or more interface inputs from the first user, the one or more interface inputs being received via the graphical user interface; and
process, by the processor, the one or more interface inputs in real-time.

17. The system of claim 16, wherein the processor is further operable to:
receive, by the processor, via the quoting interface, quote data;
obtain, by the processor, one or more quotes associated with life companies, based in part on the quote data received via the quoting interface;
identify, by the processor, a best fit quote from among the one or more quotes;
output, by the processor, the one or more quotes, wherein the best fit quote is highlighted in contrast to others of the one or more quotes, wherein the outputting is performed in real time relative to the receiving of the quote data via the quoting interface;
cause to display, by the processor, via the chronograph interface, the quote data of one of the one or more quotes;
receive, by the processor, via the chronograph interface, quote inputs; and
cause to display, by the processor, via the chronograph interface, updated quote data based in part on the quote inputs.
